(19) United States
(12) Patent Application Publication
(10) Pub. No.: US 2026/0254785 A1
(43) Pub. Date: Aug. 27, 2026

(54) SYSTEM

(71) Applicant: SoftBank Group Corp., Tokyo (JP)

(72) Inventor: Katsutoshi YOSHIDA, Tokyo (JP)

(73) Assignee: SoftBank Group Corp., Tokyo (JP)

(21) Appl. No.: 19/533,402

(22) Filed: Feb. 9, 2026

(30) Foreign Application Priority Data
Feb. 21, 2025 (JP) 2025-026987

(51) Int. Cl. H04L 51/216; G06F 3/0482; G06F 40/242

(52) U.S. Cl. CPC H04L 51/216; G06F 3/0482; G06F 40/242

(57) ABSTRACT

The system according to the embodiment comprises a reception unit, an analysis unit, a suggestion unit, and a selection unit. The reception unit is configured to receive a user input. The analysis unit is configured to analyze context based on the input received by the reception unit. The suggestion unit is configured to suggest proper nouns based on the context analyzed by the analysis unit. The selection unit is configured to allow the user to select the proper noun suggested by the suggestion unit.

### CROSS-REFERENCE TO RELATED APPLICATION

The present application claims priority to and incorporates by reference the entire contents of Japanese Patent Application No. 2025-026987 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that means for smoothly assisting input when a proper noun cannot be recalled in a messenger application are not sufficiently provided.

### SUMMARY OF THE INVENTION

The system according to the embodiment comprises a reception unit, an analysis unit, a suggestion unit, and a selection unit. The reception unit is configured to receive a user input. The analysis unit is configured to analyze context based on the input received by the reception unit. The suggestion unit is configured to suggest proper nouns based on the context analyzed by the analysis unit. The selection unit is configured to allow the user to select the proper noun suggested by the suggestion unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

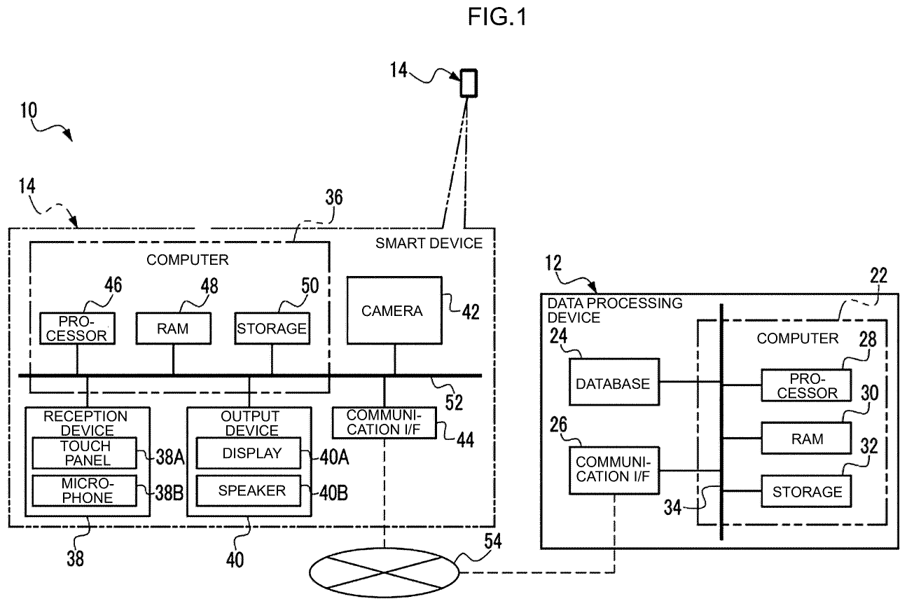

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

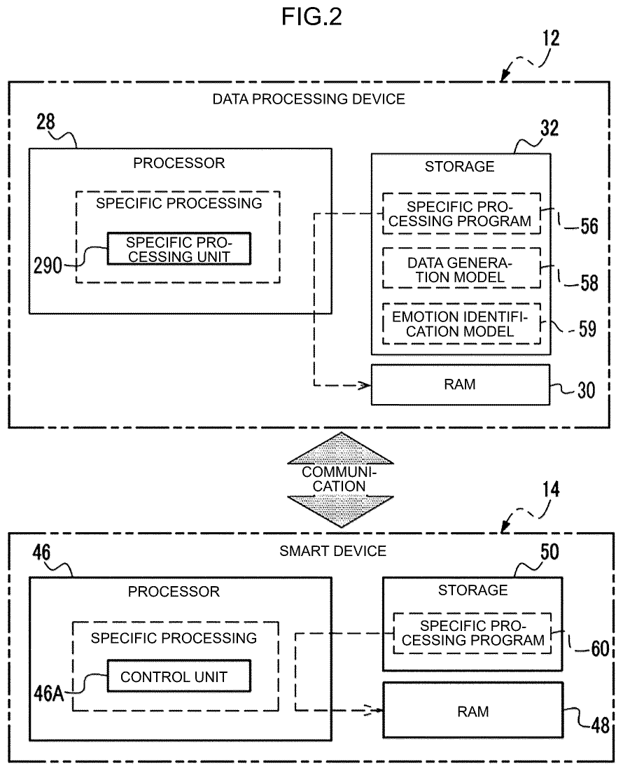

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that provides a function to invoke AI-based input assistance and reflect it in a talk when a user cannot recall a specific proper noun while composing a message in a messenger application. When a user is unable to recall a proper noun in a talk, such as “The lead actress of that ◯◯ is . . . ”, the AI analyzes the context and suggests an appropriate proper noun. The user can select the suggested proper noun and reflect it in the talk. For example, when a user cannot recall a proper noun while composing a message in a messenger application, the user invokes AI input assistance. Next, the AI analyzes the context of the talk and suggests an appropriate proper noun. For instance, for a talk such as “The lead actress of that movie is . . . ”, the AI suggests the movie title or the name of the lead actress. The user can select the suggested proper noun and reflect it in the talk. With this function, even if the user cannot recall a proper noun during a talk, the conversation can continue smoothly. Furthermore, since the AI analyzes the context and suggests an appropriate proper noun, the user can reflect accurate information in the talk. For example, when the user cannot recall a proper noun, a “reception unit” is required to invoke AI input assistance. Next, an “analysis unit” is required to analyze the context of the talk, and a “suggestion unit” is required to suggest an appropriate proper noun. Finally, a “selection unit” is required for the user to select the suggested proper noun. Four main elements are required: the reception unit, analysis unit, suggestion unit, and selection unit. These elements are interrelated. The reception unit receives the user's input, the analysis unit analyzes the context, the suggestion unit suggests proper nouns, and the selection unit receives the user's selection. As sub-elements, for example, the analysis unit may include a “reference unit” that refers to past talk history or a general database, the suggestion unit may include a “candidate presentation unit” that presents a plurality of candidates, and the selection unit may include a “reflection unit” that reflects the user's selection. Thus, when a user cannot recall a specific proper noun while composing a message in a messenger application, AI-based input assistance can be invoked and reflected in the talk. Specifically, the system receives text data (e.g., UTF-8 encoded string, context window of up to 512 tokens) input by the user via the input interface, which is received by the reception unit. The reception unit detects patterns indicating the absence of a proper noun (e.g., “The lead actress of ◯◯ is . . . ”, “The name of ◯◯ is . . . ”, etc.) using regular expressions or a trigger phrase dictionary, and upon detection, transfers the input data to the analysis unit. The analysis unit refers to input text, past talk history (e.g., up to 100 utterance logs per user stored in chronological order, in JSON format), and external knowledge bases (e.g., movie databases, person dictionaries, place name dictionaries, etc.), and extracts contextual features (e.g., topic category, most recent subject/predicate, position of missing proper noun) using natural language processing models (e.g., Transformer-based large language models, pre-trained BERT or LSTM, etc.). Examples of input to the AI model include text such as “The lead actress of that movie is . . . ”, past talk history (e.g., “The movie I watched yesterday was ◯◯”), and a movie database (e.g., “The lead actress of the movie ◯◯ is ΔΔ”). The AI model outputs a candidate list of missing proper nouns from the input context (e.g., a list of person names with scores, in probability distribution format, up to 5 items). Examples of output include “Lead actress candidates: ΔΔ (0.85), □□ (0.10), xx (0.05)”. The suggestion unit receives the output of the AI model and displays the candidate list on the user interface via the candidate presentation unit. The user selects a candidate via the selection unit, and the reflection unit automatically inserts the selected result into the body of the talk. The selection unit detects the user's selection operation (e.g., tap, click, etc.) and records the selection log in the history database. This series of processing is based on a non-conventional algorithm in which the AI integrates contextual features and knowledge base information in a high-dimensional vector space and scores proper noun candidates, unlike conventional human memory search or web search. For training the AI model, cross-entropy loss functions and supervised learning datasets (e.g., pairs of movie titles and lead actresses, pairs of conversation context and correct proper nouns, etc.) are used. As a technical effect, the system enables smooth communication without interrupting the flow of conversation by providing fast and highly accurate candidate suggestions by AI, even when the user cannot recall a proper noun. Furthermore, by improving the accuracy of proper noun suggestions, erroneous information input and the effort required for searching can be greatly reduced. Application fields include not only general messenger applications, but also business chat, customer support, educational dialogue systems, support for case reporting in medical settings, and various text input assistance scenarios.

The input assistance system for a messenger application according to the embodiment comprises a reception unit, an analysis unit, a suggestion unit, and a selection unit. The reception unit receives a user input. The user input may include, for example, text input, voice input, and the like, but is not limited thereto. For example, when a user cannot recall a proper noun while composing a message in a messenger application, the reception unit invokes AI input assistance. The analysis unit analyzes context based on the input received by the reception unit. Context analysis may include, for example, the relationship between preceding and following utterances, related topics, and the like, but is not limited thereto. The analysis unit may refer to past talk history or a general database to analyze context. The suggestion unit suggests proper nouns based on the context analyzed by the analysis unit. The suggestion of proper nouns may include, for example, personal names, place names, product names, and the like, but is not limited thereto. The suggestion unit may present a plurality of candidates. The selection unit allows the user to select the proper noun suggested by the suggestion unit. The selection unit may reflect the user's selection. Thus, even if the user cannot recall a proper noun during a talk, the conversation can continue smoothly. Some or all of the above-described processing in the analysis unit may be performed using AI or without using AI. For example, the analysis unit may input the user's input to AI and have the AI perform context analysis. Some or all of the above-described processing in the suggestion unit may be performed using AI or without using AI. For example, the suggestion unit may input the context analyzed by the analysis unit to AI and have the AI perform the suggestion of proper nouns. Some or all of the above-described processing in the selection unit may be performed using AI or without using AI. For example, the selection unit may input the proper nouns suggested by the suggestion unit to AI and have the AI perform the user's selection. Thus, the input assistance system for a messenger application according to the embodiment can receive a user input, analyze context, suggest proper nouns, and reflect the user's selection. Specifically, the input assistance system receives text data (e.g., UTF-8 encoded string, context window of up to 512 tokens) or voice data (e.g., PCM waveform sampled at 16 kHz, up to 30 seconds) received by the reception unit from the user's input interface (e.g., software keyboard, voice recognition module). The reception unit detects patterns indicating the absence of a proper noun in the input data using regular expressions or a trigger phrase dictionary (e.g., “The lead actress of ◯◯ is . . . ”, “The name of ◯◯ is . . . ”, etc.), and upon detection, transfers the input data to the analysis unit. The analysis unit inputs the text or voice to a natural language processing module (e.g., Transformer-based large language model, pre-trained BERT, LSTM, etc.) and extracts contextual features (e.g., topic category, most recent subject/predicate, position of missing proper noun). Examples of input to the AI model include text such as “The lead actress of that movie is . . . ”, past talk history (e.g., “The movie I watched yesterday was ◯◯”), and a movie database (e.g., “The lead actress of the movie ◯◯ is ΔΔ”). The AI model outputs a candidate list of missing proper nouns from the input context (e.g., a list of person names with scores, in probability distribution format, up to 5 items). Examples of output include “Lead actress candidates: ΔΔ (0.85), □□ (0.10), xx (0.05)”. The suggestion unit receives the output of the AI model and displays the candidate list on the user interface via the candidate presentation unit. The user selects a candidate via the selection unit, and the reflection unit automatically inserts the selected result into the body of the talk. The selection unit detects the user's selection operation (e.g., tap, click, etc.) and records the selection log in the history database. This series of processing is based on a non-conventional algorithm in which the AI integrates contextual features and knowledge base information in a high-dimensional vector space and scores proper noun candidates, unlike conventional human memory search or web search. For training the AI model, cross-entropy loss functions and supervised learning datasets (e.g., pairs of movie titles and lead actresses, pairs of conversation context and correct proper nouns, etc.) are used. As a technical effect, the system enables smooth communication without interrupting the flow of conversation by providing fast and highly accurate candidate suggestions by AI, even when the user cannot recall a proper noun. Furthermore, by improving the accuracy of proper noun suggestions, erroneous information input and the effort required for searching can be greatly reduced. Application fields include not only general messenger applications, but also business chat, customer support, educational dialogue systems, support for case reporting in medical settings, and various text input assistance scenarios.

The analysis unit may comprise a reference unit configured to refer to past talk history or a general database. The reference unit may, for example, refer to past talk history. Past talk history may include, for example, logs of conversations previously conducted by the user, but is not limited thereto. The reference unit may, for example, refer to a general database. A general database may include, for example, dictionary databases, knowledge bases, and the like, but is not limited thereto. By referring to past talk history or a general database, the accuracy of context analysis can be improved. Some or all of the above-described processing in the reference unit may be performed using AI or without using AI. For example, the reference unit may input past talk history or a general database to AI and have the AI perform the reference processing. Specifically, the analysis unit obtains up to 100 utterance logs per user stored in chronological order (in JSON format, with each utterance assigned a timestamp, utterance content, topic tag, etc.) and external knowledge bases (e.g., movie databases, person dictionaries, place name dictionaries, product catalogs, etc. as structured data) via the reference unit. The reference unit calculates similarity between the input context text (e.g., “The lead actress of that movie is . . . ”) and past talk history in a high-dimensional vector space (e.g., cosine similarity, Euclidean distance, etc.) and extracts highly relevant history. Furthermore, from the knowledge base, the reference unit searches for related proper noun entries based on keywords or topic categories included in the input context. When using AI, the reference unit inputs context text, history vectors, and knowledge base entities as multi-input tensors (e.g., 512-token context, 100 history items×256-dimensional vectors, 1000 knowledge base entities ×128 dimensions) to a Transformer-based large language model or pre-trained BERT, and calculates importance scores via an attention mechanism within the model. Examples of AI model output include a scored list such as “Relevant history: utterance ID123 (0.92), utterance ID87 (0.75)” and “Knowledge base candidates: person A (0.88), person B (0.65)”. These outputs are used as input for subsequent context analysis and proper noun candidate generation. For training the AI model, pairs of history and correct proper nouns, teacher data for relevance of knowledge base entities, etc. are used, and weight optimization is performed using cross-entropy loss functions or triplet loss. Unlike conventional human memory search or simple keyword search, the reference unit realizes non-conventional, high-speed, and high-accuracy information extraction by similarity calculation and attention weighting in a high-dimensional vector space. As a technical effect, by integrally referring to past talk history and knowledge bases using AI, the accuracy of context analysis is greatly improved, and the accuracy of identifying and suggesting proper nouns desired by the user is dramatically enhanced. Application fields include not only general messenger applications, but also business chat, FAQ automatic response, medical record support, educational dialogue systems, and various text input assistance scenarios where history and knowledge base reference are important.

The suggestion unit may comprise a candidate presentation unit configured to present a plurality of candidates. The candidate presentation unit may, for example, present a plurality of candidates. The plurality of candidates may include, for example, candidates for proper nouns, but is not limited thereto. The candidate presentation unit may, for example, present a plurality of proper noun candidates to the user. By presenting a plurality of candidates, the user can have options to choose from. Some or all of the above-described processing in the candidate presentation unit may be performed using AI or without using AI. For example, the candidate presentation unit may input proper noun candidates to AI and have the AI perform the candidate presentation. Specifically, the suggestion unit generates a proper noun candidate list (e.g., up to 5 items, each candidate assigned a score or relevance label) in the candidate presentation unit based on contextual features, relevant history, and knowledge base candidates received from the analysis unit. The candidate presentation unit displays the candidates on the user interface in order of score or by category (e.g., person, place name, product name, etc.). When using AI, the candidate presentation unit inputs context vectors, history vectors, and knowledge base candidate vectors as multi-input tensors (e.g., 512-token context, 5 candidates×128-dimensional candidate vectors) to a Transformer-based large language model or classifier, and outputs relevance scores or selection probability distributions for each candidate. Examples of AI model output include a scored list such as “Candidate A (0.85), Candidate B (0.10), Candidate C (0.05)”. The candidate presentation unit displays the most relevant candidates at the top based on these scores, optimizing visibility and operability of the options. Furthermore, the candidate presentation unit can also provide supplementary information for each candidate (e.g., occupation for persons, location for place names, description for product names, etc.). For training the AI model, pairwise data of correct proper nouns and candidate lists, and ranking learning using user selection history (e.g., pairwise loss, listwise loss, etc.) are applied. Unlike conventional simple list display or static candidate presentation, the candidate presentation unit realizes dynamic and highly accurate candidate presentation based on AI-integrated context, history, and knowledge base scoring. As a technical effect, the user can easily select the optimal proper noun from diverse options, reducing the risk of incorrect selection or lack of information. Application fields include not only general messenger applications, but also FAQ automatic response, customer support, medical record input assistance, educational dialogue systems, and various text input assistance scenarios where presenting multiple candidates is useful.

The selection unit may comprise a reflection unit configured to reflect the user's selection. The reflection unit may, for example, reflect the user's selection. The user's selection may include, for example, the selection of a proper noun, but is not limited thereto. The reflection unit may, for example, reflect the proper noun selected by the user in the talk. By reflecting the user's selection, appropriate proper nouns can be reflected in the talk. Some or all of the above-described processing in the reflection unit may be performed using AI or without using AI. For example, the reflection unit may input the user's selection to AI and have the AI perform the reflection processing. Specifically, the selection unit receives the proper noun selected by the user from the candidate list (e.g., selection operation by tap or click, with selection option ID or score value assigned), and the reflection unit automatically inserts the selection result into the missing position in the body of the talk. The reflection unit also records the type of selection operation (e.g., direct selection, voice command, shortcut key, etc.) and the context at the time of selection (e.g., content of the immediately preceding utterance, selection time, etc.), and saves the selection log (e.g., selection option ID, selection time, user ID, context information, etc.) in the history database. When using AI, the reflection unit inputs the user's selection content and context information as input tensors (e.g., selection option ID, context vector, history vector, etc.) to the AI model, and outputs the optimal reflection method (e.g., automatic insertion position, presence or absence of supplementary explanation, insertion format, etc.). Examples of AI model output include “Insertion position: end of sentence, supplementary explanation: present” and “Insertion format: bold”. The reflection unit automatically inserts the proper noun on the user interface based on these outputs, and provides supplementary information or emphasis as needed. For training the AI model, reinforcement learning or supervised learning using pairs of selection history and reflection results, and user satisfaction feedback are applied. Unlike conventional simple text insertion or manual editing, the reflection unit realizes optimal reflection according to the user's intent and situation by AI-integrated processing of context, history, and selection content. As a technical effect, the user can immediately and accurately reflect proper nouns in the talk after the selection operation, greatly reducing editing errors and effort. Application fields include not only general messenger applications, but also business chat, medical record input, educational dialogue systems, FAQ automatic response, and various text input assistance scenarios where selection reflection is important.

The reception unit may estimate the user's emotion and adjust the timing of invoking input assistance based on the estimated emotion of the user. The reception unit may, for example, estimate the user's emotion. The user's emotion may include, for example, impatience, relaxation, confusion, and the like, but is not limited thereto. For example, when the user is impatient, the AI immediately invokes input assistance. When the user is relaxed, input assistance is invoked with a slight delay. When the user is confused, the AI invokes input assistance at an appropriate timing. Thus, input assistance can be invoked at an appropriate timing according to the user's emotion. Emotion estimation may be realized using an emotion engine or generative AI, such as a text generation AI (e.g., LLM) or multimodal generative AI, but is not limited thereto. Some or all of the above-described processing in the reception unit may be performed using AI or without using AI. For example, the reception unit may input the user's emotion to AI and have the AI perform emotion estimation. Specifically, the reception unit extracts text data (e.g., UTF-8 encoded string, up to 512 tokens), voice data (e.g., PCM waveform sampled at 16 kHz, up to 30 seconds), and input operation logs (e.g., key input intervals, number of corrections, input interruption time, etc.) received from the user's input interface as multidimensional feature vectors. The reception unit inputs these features to an emotion estimation AI model (e.g., BERT-based emotion classifier, multimodal Transformer, etc.). Examples of input to the AI model include “Input text: ‘The lead actress of that movie is . . . ’”, “Input speed: 1.2 characters/sec”, “Input interruption: 3 times”, “Voice tone: high”, etc. The AI model outputs emotion labels (e.g., impatience, relaxation, confusion) and confidence scores (e.g., impatience 0.78, relaxation 0.12, confusion 0.10). Examples of output include “Emotion: impatience (0.78)” or “Emotion: confusion (0.65)”. Based on the output of the AI model, the reception unit executes an input assistance invocation timing determination algorithm (e.g., threshold judgment, priority scheduler, etc.), and dynamically controls invocation, such as immediate invocation upon “impatience” judgment, 3-second delay upon “relaxation” judgment, and invocation after detecting user input stop upon “confusion” judgment. For training the AI model, input datasets with emotion labels (e.g., pairs of user input and self-reported emotion, combinations of voice, text, and operation logs) are used, and cross-entropy loss functions and multitask learning are applied. In subsequent processing, the emotion estimation result serves as a trigger for invoking the input assistance module, and the timing of data transfer to the analysis unit or suggestion unit is optimized. Unlike conventional invocation by simple timers or fixed rules, the reception unit realizes non-conventional timing control based on AI analysis of multidimensional features and emotion estimation. As a technical effect, the system can provide input assistance timing suited to the user's psychological state, resulting in improved user experience, reduced input stress, and minimized risk of conversation interruption. Application fields include not only general messenger applications, but also business chat, support for case input in medical settings, educational dialogue systems, customer support, and various scenarios where input assistance according to user emotion is required.

The reception unit may analyze the user's past input history and select an appropriate reception method. The reception unit may, for example, analyze the user's past input history. Past input history may include, for example, logs of inputs previously performed by the user, but is not limited thereto. The reception unit may, for example, preferentially suggest input methods frequently used by the user in the past. The reception unit may, for example, detect specific patterns from the user's past input history and select an appropriate reception method. The reception unit may, for example, propose the most efficient reception method based on the user's past input history. Thus, by providing an appropriate reception method based on the user's past input history, efficient input assistance can be realized. Some or all of the above-described processing in the reception unit may be performed using AI or without using AI. For example, the reception unit may input the user's past input history to AI and have the AI perform history analysis. Specifically, the reception unit obtains input history data stored in chronological order for each user (e.g., text input, voice input, image attachment, input device type, input time, input speed, number of corrections, etc. in JSON structure, up to 1000 items) from the database. The reception unit extracts these history data as feature vectors (e.g., input method category, input frequency, input success rate, input time distribution, etc.) and inputs them to an AI model (e.g., LSTM-based time series pattern recognition model, Transformer-based history analysis model, etc.). Examples of input to the AI model include “Input methods for the past 30 entries: text 25, voice 5”, “Input success rate: text 0.98, voice 0.85”, “Input time: mostly at night”, etc. The AI model outputs the optimal reception method (e.g., text input priority, voice input priority, combined image input, etc.) and recommendation scores (e.g., text 0.92, voice 0.08). Examples of output include “Recommended reception method: text (0.92)” or “Recommended reception method: voice (0.75)”. Based on the output of the AI model, the reception unit automatically selects or preferentially displays the recommended reception method on the user interface, enabling the user to input efficiently. For training the AI model, pairs of history data and user satisfaction/input success rate are used, and cross-entropy loss functions and reinforcement learning are applied. In subsequent processing, the recommended reception method is reflected in the initial settings of the reception unit's input reception module or input assistance trigger. Unlike conventional simple history reference or static reception method selection, the reception unit realizes multidimensional history analysis and dynamic reception method optimization by AI. As a technical effect, the system can automatically propose a reception method suited to each user's input tendencies and efficiency, resulting in reduced input errors, improved input speed, and optimized user experience. Application fields include not only general messenger applications, but also business chat, medical record input assistance, educational dialogue systems, customer support, and various scenarios where optimal input reception for each user is required.

The reception unit may automatically start reception using specific keywords or phrases as triggers according to the content of the talk. The reception unit may, for example, automatically start reception using specific keywords or phrases as triggers according to the content of the talk. Specific keywords or phrases may include, for example, “The lead actress of ◯◯ is . . . ”, “The location of ◯◯ is . . . ”, “The name of ◯◯ is . . . ”, and the like, but are not limited thereto. For example, when the user inputs “The lead actress of ◯◯ is . . . ”, the reception unit automatically starts reception. When the user inputs “The location of ◯◯ is . . . ”, the reception unit automatically starts reception. When the user inputs “The name of ◯◯ is . . . ”, the reception unit automatically starts reception. Thus, by automatically starting reception using specific keywords or phrases as triggers, the user's effort can be reduced. Some or all of the above-described processing in the reception unit may be performed using AI or without using AI. For example, the reception unit may input the content of the talk to AI and have the AI perform keyword or phrase detection. Specifically, the reception unit monitors text data (e.g., UTF-8 encoded string, up to 512 tokens) received from the user's input interface in real time, and detects keywords using regular expression pattern matching or a trigger phrase dictionary (e.g., more than 1000 patterns of proper noun absence). Furthermore, the reception unit inputs the text to an AI model (e.g., BERT-based context classifier, Transformer-based trigger detection model, etc.) to accurately determine the contextually missing proper noun or the part requiring input assistance. Examples of input to the AI model include “Input text: ‘The lead actress of that movie is . . . ’”, “Previous utterance: ‘The movie I watched yesterday was ◯◯’”, etc. The AI model outputs trigger detection labels (e.g., proper noun absence trigger, normal utterance, question sentence, etc.) and detection confidence scores (e.g., trigger 0.95, normal 0.05). Examples of output include “Trigger detection: proper noun absence (0.95)”. Based on the output of the AI model and pattern matching results, the reception unit automatically activates the input assistance reception module and starts data transfer to the analysis unit or suggestion unit. For training the AI model, conversation datasets with trigger phrases and data labeled for proper noun absence are used, and cross-entropy loss functions and data augmentation techniques are applied. In subsequent processing, the trigger detection result serves as the start condition for the input assistance workflow, and the assistance function operates automatically while minimizing user operations. Unlike conventional simple keyword detection or static rule-based approaches, the reception unit realizes non-conventional reception start control by combining AI-based context understanding and dynamic trigger determination. As a technical effect, the system realizes automatic reception suited to the user's input intent and context, greatly reducing the effort and time lag for invoking input assistance. Application fields include not only general messenger applications, but also FAQ automatic response, medical record input assistance, educational dialogue systems, customer support, and various scenarios where automatic trigger detection is useful.

The reception unit may estimate the user's emotion and determine the priority of inputs to be received based on the estimated emotion of the user. The reception unit may, for example, estimate the user's emotion. The user's emotion may include, for example, impatience, relaxation, confusion, and the like, but is not limited thereto. For example, when the user is impatient, important inputs are preferentially received. When the user is relaxed, inputs are received in the normal order. When the user is confused, the AI receives inputs in an appropriate priority order. Thus, by determining the priority of inputs according to the user's emotion, important inputs can be preferentially received. Emotion estimation may be realized using an emotion engine or generative AI, such as a text generation AI (e.g., LLM) or multimodal generative AI, but is not limited thereto. Some or all of the above-described processing in the reception unit may be performed using AI or without using AI. For example, the reception unit may input the user's emotion to AI and have the AI perform emotion estimation. Specifically, the reception unit extracts text data, voice data, and input operation logs (e.g., key input intervals, number of corrections, input interruption time, etc.) received from the user's input interface as multidimensional feature vectors, and inputs them to an emotion estimation AI model (e.g., BERT-based emotion classifier, multimodal Transformer, etc.). Examples of input to the AI model include “Input text: ‘Please respond urgently’”, “Input speed: 2.0 characters/sec”, “Input interruption: 0 times”, etc. The AI model outputs emotion labels (e.g., impatience, relaxation, confusion) and confidence scores (e.g., impatience 0.85, relaxation 0.10, confusion 0.05). Examples of output include “Emotion: impatience (0.85)” or “Emotion: confusion (0.60)”. Based on the output of the AI model, the reception unit executes an input reception priority determination algorithm (e.g., importance scoring, priority queue, etc.), and, for example, upon “impatience” judgment, preferentially receives important inputs (e.g., missing proper noun positions, question sentences, etc.), upon “relaxation” judgment, receives inputs in the normal order, and upon “confusion” judgment, the AI automatically adjusts the priority order. For training the AI model, input datasets with emotion labels and input priority labels are used, and cross-entropy loss functions and reinforcement learning are applied. In subsequent processing, the priority determination result is reflected in the reception order of the input assistance workflow and the data transfer order to the analysis unit. Unlike conventional simple reception order or static rule-based approaches, the reception unit realizes dynamic priority control based on AI analysis of multidimensional features and emotion estimation. As a technical effect, the system realizes input reception suited to the user's psychological state and urgency, preventing missed important inputs, improving conversation efficiency, and optimizing user experience. Application fields include not only general messenger applications, but also business chat, support for case input in medical settings, educational dialogue systems, customer support, and various scenarios where input priority control is required.

The reception unit may preferentially receive region-specific proper nouns based on the user's geographic location information. The reception unit may, for example, consider the user's geographic location information and preferentially receive region-specific proper nouns. Region-specific proper nouns may include, for example, place names, local specialties, and the like, but are not limited thereto. For example, when the user is in a specific region, the reception unit preferentially receives proper nouns related to that region. When the user is traveling, the reception unit preferentially receives proper nouns related to the travel destination. When the user is in their hometown, the reception unit preferentially receives proper nouns related to the hometown. Thus, by preferentially receiving region-specific proper nouns based on the user's geographic location information, information related to the region can be provided. Some or all of the above-described processing in the reception unit may be performed using AI or without using AI. For example, the reception unit may input the user's geographic location information to AI and have the AI perform prioritization of proper nouns. Specifically, the reception unit obtains geographic location information (e.g., GPS coordinates, Wi-Fi location information, region estimation based on IP address, etc.) from the user terminal in real time and extracts it as a location information vector (e.g., latitude/longitude, region code, movement history, etc.). The reception unit combines this location information with input text (e.g., UTF-8 encoded string, up to 512 tokens) and matches it with a region-specific proper noun dictionary (e.g., prefecture-based place name list, local specialty list, tourist spot database, etc.). Furthermore, the reception unit inputs the location information vector and input text to an AI model (e.g., Transformer-based region relevance estimation model, geographic information embedding model, etc.) and calculates priority scores for region-specific proper nouns (e.g., hometown 0.90, travel destination 0.80, other regions 0.10). Examples of input to the AI model include “Location information: Chiyoda-ku, Tokyo”, “Input text: ‘Recommended tourist spots are . . . ’”, etc. The AI model outputs a candidate list of proper nouns (e.g., Tokyo Tower 0.85, Sensoji Temple 0.80, Skytree 0.75) and priority labels. Examples of output include “Priority candidate: Tokyo Tower (0.85)”. Based on the output of the AI model, the reception unit preferentially receives region-specific proper nouns and attaches priority information when transferring data to the analysis unit or suggestion unit. For training the AI model, input datasets with location information and region-related proper noun labels are used, and cross-entropy loss functions and ranking learning are applied. In subsequent processing, the result of preferential reception of region-specific proper nouns is reflected in candidate generation by the suggestion unit and option presentation by the selection unit. Unlike conventional simple place name dictionary reference or static rule-based approaches, the reception unit realizes dynamic prioritization of proper noun reception based on AI-integrated analysis of location information and context. As a technical effect, the system can provide highly accurate region-related information suited to the user's current location and movement status, improving user experience in tourist guidance, region-limited services, and local information support. Application fields include not only general messenger applications, but also tourist guide applications, region-focused services, business chat, educational dialogue systems, and various scenarios where location-linked input assistance is required.

The reception unit may analyze the user's social media activity and preferentially receive related inputs. The reception unit may, for example, analyze the user's social media activity. Social media activity may include, for example, post content, number of followers, and the like, but is not limited thereto. For example, the reception unit preferentially receives proper nouns frequently used by the user on social media. The reception unit preferentially receives proper nouns related to topics discussed by the user on social media. The reception unit preferentially receives related proper nouns based on the user's social media activity. Thus, by analyzing the user's social media activity, related inputs can be preferentially received. Some or all of the above-described processing in the reception unit may be performed using AI or without using AI. For example, the reception unit may input the user's social media activity to AI and have the AI perform prioritization of related proper nouns. Specifically, the reception unit collects post data (e.g., text posts, image captions, hashtags, post time, number of followers, engagement metrics, etc.) obtained from social media accounts linked by the user (e.g., microblogging, photo sharing services, video posting services, etc.) in chronological order and extracts them as feature vectors (e.g., frequent word list, topic category distribution, proper noun occurrence frequency, trend score, etc.). The reception unit combines these features with the user's input text (e.g., UTF-8 encoded string, up to 512 tokens) and inputs them to an AI model (e.g., Transformer-based topic relevance estimation model, graph neural network, etc.). Examples of input to the AI model include “Recent post: ‘The new movie ◯◯ was interesting’”, “Frequent proper nouns: ◯◯, ΔΔ”, “Input text: 'The lead actress is . . . '”, etc. The AI model outputs a candidate list of related proper nouns (e.g., ◯◯ 0.90, ΔΔ 0.80, □□ 0.60) and priority scores. Examples of output include “Priority candidate: ◯◯ (0.90)” or “Priority candidate: ΔΔ (0.80)”. Based on the output of the AI model, the reception unit preferentially receives proper nouns and topics with high relevance on social media and attaches priority information when transferring data to the analysis unit or suggestion unit. For training the AI model, social media posts and data labeled for proper noun relevance are used, and cross-entropy loss functions and ranking learning are applied. In subsequent processing, the result of preferential reception is reflected in candidate generation by the suggestion unit and option presentation by the selection unit. Unlike conventional simple keyword frequency reference or static rule-based approaches, the reception unit realizes dynamic prioritization of proper noun reception based on AI-integrated analysis of social media activity and context. As a technical effect, the system can provide highly accurate related information suited to the user's latest interests and trends, enabling support for highly topical conversations, improved information freshness, and optimized user experience. Application fields include not only general messenger applications, but also SNS-linked chat, marketing support, educational dialogue systems, customer support, and various scenarios where social media-linked input assistance is required.

The analysis unit may estimate the user's emotion and adjust the accuracy of context analysis based on the estimated emotion of the user. The analysis unit may, for example, estimate the user's emotion. The user's emotion may include, for example, relaxation, urgency, confusion, and the like, but is not limited thereto. For example, when the user is relaxed, detailed context analysis is performed. When the user is in a hurry, simplified context analysis is performed. When the user is confused, highly accurate context analysis is performed. Thus, by adjusting the accuracy of context analysis according to the user's emotion, more appropriate analysis results can be provided. Emotion estimation may be realized using an emotion engine or generative AI, such as a text generation AI (e.g., LLM) or multimodal generative AI, but is not limited thereto. Some or all of the above-described processing in the analysis unit may be performed using AI or without using AI. For example, the analysis unit may input the user's emotion to AI and have the AI perform emotion estimation. Specifically, the analysis unit extracts text data (e.g., UTF-8 encoded string, up to 512 tokens), voice data (e.g., PCM waveform sampled at 16 kHz, up to 30 seconds), and input operation logs (e.g., key input intervals, number of corrections, input interruption time, etc.) received from the user's input interface as multidimensional feature vectors. The analysis unit inputs these features to an emotion estimation AI model (e.g., BERT-based emotion classifier, multimodal Transformer, etc.), which outputs emotion labels (e.g., relaxation, urgency, confusion) and confidence scores (e.g., relaxation 0.70, urgency 0.20, confusion 0.10). Examples of input to the AI model include “Input text: ‘The lead actress of that movie is . . . ’”, “Input speed: 1.2 characters/sec”, “Input interruption: 3 times”, “Voice tone: high”, etc. Examples of AI model output include “Emotion: relaxation (0.70)” or “Emotion: urgency (0.20)”. Based on the output of the AI model, the analysis unit selects a context analysis accuracy control algorithm (e.g., detailed analysis mode, simplified analysis mode, precise analysis mode, etc.). For example, upon relaxation judgment, detailed context analysis using a Transformer-based large language model with multi-stage attention mechanism is performed; upon urgency judgment, a simplified algorithm extracting only major features is applied; and upon confusion judgment, high-accuracy analysis with enhanced history reference and knowledge base integration is performed. For training the AI model, input datasets with emotion labels and analysis accuracy labels are used, and cross-entropy loss functions and multitask learning are applied. Examples of input to the AI include “Input text: ‘Please respond urgently’”, “Input speed: 2.0 characters/sec”, “Input interruption: 0 times”, etc., and examples of output include “Emotion: urgency (0.85)”. In subsequent processing, the result of analysis accuracy control is reflected in proper noun candidate generation and data transfer methods to the suggestion unit. Unlike conventional uniform context analysis, the analysis unit realizes dynamic accuracy control based on AI analysis of multidimensional features and emotion estimation. As a technical effect, the system can automatically optimize analysis accuracy according to the user's psychological state and situation, resulting in improved reliability of analysis results, optimized processing speed, and enhanced user experience. Application fields include not only general messenger applications, but also business chat, support for case input in medical settings, educational dialogue systems, customer support, and various scenarios where accuracy control according to user emotion is required.

The analysis unit may refer to past talk history during context analysis to improve the accuracy of the analysis. The analysis unit may, for example, refer to past talk history during context analysis. Past talk history may include, for example, logs of conversations previously conducted by the user, but is not limited thereto. The analysis unit may, for example, refer to the user's past talk history to improve the accuracy of context analysis. The analysis unit may, for example, improve the accuracy of context analysis based on proper nouns previously used by the user. The analysis unit may, for example, detect specific patterns from the user's past talk history to improve the accuracy of context analysis. Thus, by referring to past talk history, the accuracy of context analysis can be improved. Some or all of the above-described processing in the analysis unit may be performed using AI or without using AI. For example, the analysis unit may input past talk history to AI and have the AI perform accuracy improvement of context analysis. Specifically, the analysis unit obtains up to 1000 utterance logs per user stored in chronological order (in JSON format, with each utterance assigned a timestamp, utterance content, topic tag, etc.) from the database, and inputs them together with input text (e.g., UTF-8 encoded string, up to 512 tokens) to an AI model (e.g., Transformer-based history-referencing large language model, LSTM-based time series analysis model, etc.). The analysis unit extracts features such as frequent proper noun lists, topic transition patterns, and user-specific language expressions from the history data, and calculates similarity with the input context (e.g., cosine similarity, vector inner product, etc.). Examples of input to the AI model include “Input text: ‘The lead actress of that movie is . . . ’”, “Past utterance: ‘The movie I watched yesterday was ◯◯’”, “Frequent proper nouns: ◯◯, ΔΔ”, etc. The AI model outputs a scored list of relevant history (e.g., utterance ID123 (0.92), utterance ID87 (0.75)), and a candidate list of proper nouns (e.g., ΔΔ 0.85, □□ 0.10, xx 0.05). Examples of output include “Relevant history: utterance ID123 (0.92)” and “Proper noun candidate: ΔΔ (0.85)”. Based on the output of the AI model, the analysis unit dynamically adjusts the weighting of the context analysis algorithm and the priority of candidate generation. For training the AI model, pairs of history and correct proper nouns, and data labeled for analysis accuracy with or without history reference are used, and weight optimization is performed using cross-entropy loss functions or triplet loss. In subsequent processing, the result of history reference is reflected in proper noun candidate generation and data transfer to the suggestion unit. Unlike conventional simple keyword search or static history reference, the analysis unit realizes non-conventional and highly accurate context analysis by AI-integrated history analysis in a high-dimensional vector space and dynamic weighting. As a technical effect, the system enables analysis reflecting the user's past utterance tendencies and expression patterns, greatly improving the accuracy of proper noun identification and conversation continuity. Application fields include not only general messenger applications, but also business chat, FAQ automatic response, medical record support, educational dialogue systems, and various text input assistance scenarios where history reference is important.

The analysis unit may apply different analysis algorithms according to the category of the talk during context analysis. The analysis unit may, for example, apply different analysis algorithms according to the category of the talk during context analysis. Categories of talk may include, for example, movies, music, sports, and the like, but are not limited thereto. For example, for talks about movies, the analysis unit applies a movie-related analysis algorithm. For talks about music, the analysis unit applies a music-related analysis algorithm. For talks about sports, the analysis unit applies a sports-related analysis algorithm. Thus, by applying different analysis algorithms according to the category of the talk, the accuracy of the analysis can be improved. Some or all of the above-described processing in the analysis unit may be performed using AI or without using AI. For example, the analysis unit may input the category of the talk to AI and have the AI apply the analysis algorithm. Specifically, the analysis unit inputs the text (e.g., UTF-8 encoded string, up to 512 tokens) to a natural language processing model (e.g., Transformer-based large language model, BERT, LSTM, etc.), and first determines the category of the talk (e.g., movie, music, sports, business, etc.) using a topic classifier (e.g., multi-class classifier trained with category-labeled teacher data). Examples of input to the AI model include “Input text: ‘Recommended movies are . . . ’”, “Input text: ‘Recent hit songs are . . . ’”, etc. The AI model outputs category labels (e.g., movie 0.95, music 0.03, sports 0.02). Examples of output include “Category: movie (0.95)” or “Category: music (0.90)”. Based on the category determination result, the analysis unit automatically selects an analysis algorithm optimized for each category (e.g., referencing a movie database for the movie category, referencing a lyrics/artist dictionary for the music category, referencing a sports type/player name dictionary for the sports category, etc.), and executes contextual feature extraction and proper noun candidate generation. For training the AI model, conversation datasets with category labels and data labeled for analysis accuracy by category are used, and cross-entropy loss functions and multitask learning are applied. In subsequent processing, the category-specific analysis result is reflected in candidate generation by the suggestion unit and option presentation by the selection unit. Unlike conventional uniform application of analysis algorithms, the analysis unit realizes non-conventional and highly accurate context analysis by AI-based category determination and dynamic algorithm switching. As a technical effect, the system can automatically select an analysis method suited to the content of the talk, greatly improving the accuracy of proper noun identification and user satisfaction. Application fields include not only general messenger applications, but also FAQ automatic response, medical record support, educational dialogue systems, customer support, and various scenarios where category-specific analysis is useful.

The analysis unit may estimate the user's emotion and adjust the display method of analysis results based on the estimated emotion of the user. The analysis unit may, for example, estimate the user's emotion. The user's emotion may include, for example, tension, relaxation, urgency, and the like, but is not limited thereto. For example, when the user is tense, a simple and highly visible display method is provided. When the user is relaxed, a display method including detailed information is provided. When the user is in a hurry, a display method focusing on key points is provided. Thus, by adjusting the display method of analysis results according to the user's emotion, a display that is easy for the user to view can be provided. Emotion estimation may be realized using an emotion engine or generative AI, such as a text generation AI (e.g., LLM) or multimodal generative AI, but is not limited thereto. Some or all of the above-described processing in the analysis unit may be performed using AI or without using AI. For example, the analysis unit may input the user's emotion to AI and have the AI perform emotion estimation. Specifically, the analysis unit extracts text data (e.g., UTF-8 encoded string, up to 512 tokens), voice data (e.g., PCM waveform sampled at 16 kHz, up to 30 seconds), and input operation logs (e.g., key input intervals, number of corrections, input interruption time, etc.) received from the user's input interface as multidimensional feature vectors. The analysis unit inputs these features to an emotion estimation AI model (e.g., BERT-based emotion classifier, multimodal Transformer, etc.), which outputs emotion labels (e.g., tension, relaxation, urgency) and confidence scores (e.g., tension 0.65, relaxation 0.25, urgency 0.10). Examples of input to the AI model include “Input text: ‘Please respond immediately’”, “Input speed: 2.5 characters/sec”, “Input interruption: 0 times”, “Voice tone: low”, etc. Examples of AI model output include “Emotion: tension (0.65)” or “Emotion: relaxation (0.25)”. Based on the output of the AI model, the analysis unit selects an analysis result display control algorithm (e.g., simple display mode, detailed display mode, key point display mode, etc.). For example, upon tension judgment, only the main proper noun candidates are emphasized in large font; upon relaxation judgment, supplementary information and related history are displayed in detail for each candidate; and upon urgency judgment, only key points are concisely displayed in bullet points. For training the AI model, input datasets with emotion labels and data labeled for display method satisfaction are used, and cross-entropy loss functions and multitask learning are applied. Examples of input to the AI include “Input text: ‘Tell me now’”, “Input speed: 3.0 characters/sec”, “Input interruption: 0 times”, etc., and examples of output include “Emotion: urgency (0.80)”. In subsequent processing, the result of display method control is reflected in the rendering module of the user interface, and optimal display suited to the user's psychological state and situation is automatically realized. Unlike conventional uniform display methods or static UIs, the analysis unit realizes dynamic display method control based on AI analysis of multidimensional features and emotion estimation. As a technical effect, the system can automatically optimize the display of analysis results according to the user's psychological state and situation, resulting in improved visibility of information, prevention of misrecognition, and enhanced user experience. Application fields include not only general messenger applications, but also business chat, support for case input in medical settings, educational dialogue systems, customer support, and various scenarios where display control according to user emotion is required.

The analysis unit may perform analysis based on the user's geographic location information during context analysis. The analysis unit may, for example, consider the user's geographic location information during context analysis. Geographic location information may include, for example, GPS data, location information services, and the like, but is not limited thereto. For example, when the user is in a specific region, the analysis unit preferentially analyzes information related to that region. When the user is traveling, the analysis unit preferentially analyzes information related to the travel destination. When the user is in their hometown, the analysis unit preferentially analyzes information related to the hometown. Thus, by performing analysis based on the user's geographic location information, information related to the region can be provided. Some or all of the above-described processing in the analysis unit may be performed using AI or without using AI. For example, the analysis unit may input the user's geographic location information to AI and have the AI perform the analysis. Specifically, the analysis unit obtains geographic location information (e.g., GPS coordinates, Wi-Fi location information, region estimation based on IP address, etc.) from the user terminal in real time and extracts it as a location information vector (e.g., latitude/longitude, region code, movement history, etc.). The analysis unit combines this location information with input text (e.g., UTF-8 encoded string, up to 512 tokens) and matches it with a region-specific proper noun dictionary (e.g., prefecture-based place name list, local specialty list, tourist spot database, etc.). Furthermore, the analysis unit inputs the location information vector and input text to an AI model (e.g., Transformer-based region relevance estimation model, geographic information embedding model, etc.) and calculates priority scores for region-specific proper nouns (e.g., hometown 0.90, travel destination 0.80, other regions 0.10). Examples of input to the AI model include “Location information: Kita-ku, Osaka”, “Input text: ‘Recommended gourmet foods are . . . ’”, etc. The AI model outputs a candidate list of proper nouns (e.g., takoyaki 0.85, okonomiyaki 0.80, kushikatsu 0.75) and priority labels. Examples of output include “Priority candidate: takoyaki (0.85)”. Based on the output of the AI model, the analysis unit preferentially analyzes region-specific proper nouns and attaches priority information when transferring data to the suggestion unit or selection unit. For training the AI model, input datasets with location information and region-related proper noun labels are used, and cross-entropy loss functions and ranking learning are applied. In subsequent processing, the result of preferential analysis of region-specific proper nouns is reflected in candidate generation by the suggestion unit and option presentation by the selection unit. Unlike conventional simple place name dictionary reference or static rule-based approaches, the analysis unit realizes dynamic prioritization of proper noun analysis based on AI-integrated analysis of location information and context. As a technical effect, the system can provide highly accurate region-related information suited to the user's current location and movement status, improving user experience in tourist guidance, region-limited services, and local information support. Application fields include not only general messenger applications, but also tourist guide applications, region-focused services, business chat, educational dialogue systems, and various scenarios where location-linked input assistance is required.

The analysis unit may refer to relevant news or trend information during context analysis to improve the accuracy of the analysis. The analysis unit may, for example, refer to relevant news or trend information during context analysis. News or trend information may include, for example, news feeds, trend databases, and the like, but is not limited thereto. For example, the analysis unit refers to the latest news to improve the accuracy of context analysis. The analysis unit refers to trend information to improve the accuracy of context analysis. The analysis unit improves the accuracy of context analysis based on relevant news or trend information. Thus, by referring to relevant news or trend information, the accuracy of context analysis can be improved. Some or all of the above-described processing in the analysis unit may be performed using AI or without using AI. For example, the analysis unit may input news or trend information to AI and have the AI perform accuracy improvement of the analysis. Specifically, the analysis unit collects structured data such as the latest news titles, body text, topic tags, and publication dates obtained from external news APIs or trend information databases (e.g., RSS feeds, SNS trend rankings, news article metadata, etc.). The analysis unit combines these news and trend data with the user's input text (e.g., UTF-8 encoded string, up to 512 tokens) and inputs them to a natural language processing model (e.g., Transformer-based news relevance estimation model, BERT-based topic matching model, etc.). Examples of input to the AI model include “Input text: ‘Recently popular movies are . . . ’”, “News title: ‘New movie ◯◯ released’”, “Trend tag: #movie”, etc. The AI model outputs a candidate list of relevant news (e.g., news ID123 (0.92), news ID87 (0.75)), and a candidate list of proper nouns with trend scores (e.g., ◯◯ 0.88, ΔΔ 0.65). Examples of output include “Relevant news: news ID123 (0.92)” and “Proper noun candidate: ◯◯ (0.88)”. Based on the output of the AI model, the analysis unit dynamically adjusts the weighting of the context analysis algorithm and the priority of candidate generation. For training the AI model, pairs of news/trend data and correct proper nouns, and data labeled for relevance are used, and cross-entropy loss functions and ranking learning are applied. In subsequent processing, the result of news/trend reference is reflected in proper noun candidate generation and data transfer to the suggestion unit. Unlike conventional simple keyword search or static news reference, the analysis unit realizes non-conventional and highly accurate context analysis by AI-integrated news/trend analysis in a high-dimensional vector space and dynamic weighting. As a technical effect, the system enables analysis reflecting the user's latest interests and social trends, greatly improving the accuracy of proper noun identification and freshness of conversation. Application fields include not only general messenger applications, but also SNS-linked chat, marketing support, educational dialogue systems, customer support, and various text input assistance scenarios where news/trend reference is important.

The suggestion unit may estimate the user's emotion and adjust the expression method of suggestions based on the estimated emotion of the user. The suggestion unit may, for example, estimate the user's emotion. The user's emotion may include, for example, relaxation, urgency, confusion, and the like, but is not limited thereto. For example, when the user is relaxed, detailed suggestions are provided. When the user is in a hurry, concise suggestions are provided. When the user is confused, easy-to-understand suggestions are provided. Thus, by adjusting the expression method of suggestions according to the user's emotion, more appropriate suggestions can be provided. Emotion estimation may be realized using an emotion engine or generative AI, such as a text generation AI (e.g., LLM) or multimodal generative AI, but is not limited thereto. Some or all of the above-described processing in the suggestion unit may be performed using AI or without using AI. For example, the suggestion unit may input the user's emotion to AI and have the AI perform emotion estimation. Specifically, the suggestion unit extracts text data (e.g., UTF-8 encoded string, up to 512 tokens), voice data (e.g., PCM waveform sampled at 16 kHz, up to 30 seconds), and input operation logs (e.g., key input intervals, number of corrections, input interruption time, etc.) received from the user's input interface as multidimensional feature vectors. The suggestion unit inputs these features to an emotion estimation AI model (e.g., BERT-based emotion classifier, multimodal Transformer, etc.), which outputs emotion labels (e.g., relaxation, urgency, confusion) and confidence scores (e.g., relaxation 0.70, urgency 0.20, confusion 0.10). Examples of input to the AI model include “Input text: ‘The lead actress of that movie is . . . ’”, “Input speed: 1.2 characters/sec”, “Input interruption: 3 times”, “Voice tone: high”, etc. Examples of AI model output include “Emotion: relaxation (0.70)” or “Emotion: urgency (0.20)”. Based on the output of the AI model, the suggestion unit selects a suggestion expression control algorithm (e.g., detailed suggestion mode, concise suggestion mode, easy-to-understand mode, etc.). For example, upon relaxation judgment, supplementary information and related history are displayed in detail for each proper noun candidate; upon urgency judgment, only the main proper noun candidates are presented concisely; and upon confusion judgment, explanations or example sentences are provided for each candidate to make the suggestions easy to understand. For training the AI model, input datasets with emotion labels and data labeled for suggestion expression satisfaction are used, and cross-entropy loss functions and multitask learning are applied. Examples of input to the AI include “Input text: ‘Tell me now’”, “Input speed: 3.0 characters/sec”, “Input interruption: 0 times”, etc., and examples of output include “Emotion: urgency (0.80)”. In subsequent processing, the result of expression method control is reflected in the rendering module of the user interface, and optimal suggestion expression suited to the user's psychological state and situation is automatically realized. Unlike conventional uniform suggestion expression or static UIs, the suggestion unit realizes dynamic suggestion expression control based on AI analysis of multidimensional features and emotion estimation. As a technical effect, the system can automatically optimize suggestion expression according to the user's psychological state and situation, resulting in improved visibility of information, prevention of misrecognition, and enhanced user experience. Application fields include not only general messenger applications, but also business chat, support for case input in medical settings, educational dialogue systems, customer support, and various scenarios where suggestion expression control according to user emotion is required.

The suggestion unit may adjust the level of detail of suggestions based on the importance of the proper noun at the time of suggestion. The suggestion unit may, for example, adjust the level of detail of suggestions based on the importance of the proper noun. The importance of the proper noun may include, for example, frequency, relevance, and the like, but is not limited thereto. For example, for important proper nouns, the suggestion unit provides suggestions including detailed information. For general proper nouns, the suggestion unit provides concise suggestions. For proper nouns that are important in a specific context, the suggestion unit provides context-dependent detailed suggestions. Thus, by adjusting the level of detail of suggestions based on the importance of the proper noun, important information can be provided to the user. Some or all of the above-described processing in the suggestion unit may be performed using AI or without using AI. For example, the suggestion unit may input the importance of the proper noun to AI and have the AI perform adjustment of the level of detail of suggestions. Specifically, the suggestion unit calculates an importance score (e.g., frequency of occurrence, contextual relevance, weighting based on user selection history, etc.) for each proper noun candidate received from the analysis unit. The AI model (e.g., Transformer-based importance estimation model, ranking learning model, etc.) receives as input the proper noun candidate vector (e.g., 128-dimensional features), history data (e.g., past 100 selection history items), and context vector (e.g., 512-token contextual features), and outputs an importance score for each proper noun (e.g., 0.95, 0.60, 0.20, etc.). Examples of input to the AI model include “Proper noun: ΔΔ, frequency: high, relevance: 0.92”, “Proper noun: □□, frequency: low, relevance: 0.45”, etc. Examples of AI model output include “Importance: ΔΔ (0.95)” and “Importance: □□ (0.45)”. Based on the importance score, the suggestion unit applies a level-of-detail control algorithm (e.g., addition of detailed information, concise display, context-dependent explanation, etc.), and provides detailed information such as explanatory text, related news, image links, etc. for important proper nouns, and presents only concise labels for general proper nouns. For training the AI model, data labeled for proper noun importance and user satisfaction feedback are used, and cross-entropy loss functions and ranking learning are applied. In subsequent processing, the result of level-of-detail control is reflected in the candidate presentation module of the user interface, enabling the user to easily identify important information. Unlike conventional uniform candidate presentation, the suggestion unit realizes information provision suited to user needs by AI-based importance estimation and dynamic level-of-detail control. As a technical effect, the system prevents excess or deficiency of information required by the user, reducing confusion due to incorrect selection or information overload. Application fields include not only general messenger applications, but also FAQ automatic response, medical record input assistance, educational dialogue systems, customer support, and various scenarios where information presentation according to importance is useful.

The suggestion unit can apply different suggestion algorithms according to the category of the proper noun at the time of suggestion. For example, the suggestion unit applies different suggestion algorithms depending on the category of the proper noun. Categories of proper nouns include, for example, personal names, place names, product names, and the like, but are not limited thereto. For instance, in the case of proper nouns related to movies, the suggestion unit applies a movie-related suggestion algorithm. In the case of proper nouns related to music, the suggestion unit applies a music-related suggestion algorithm. In the case of proper nouns related to sports, the suggestion unit applies a sports-related suggestion algorithm. By applying different suggestion algorithms according to the category of the proper noun, the accuracy of suggestions is improved. Some or all of the above-described processing in the suggestion unit may be performed using AI, or may be performed without using AI. For example, the suggestion unit may input the category of the proper noun to AI and have the AI execute the application of the suggestion algorithm. Specifically, for each proper noun candidate received from the analysis unit, the suggestion unit assigns a category label (e.g., personal name, place name, product name, movie, music, sports, etc.) using a category determination module (e.g., multi-class classifier, BERT-based category classification model, etc.). Examples of inputs to the AI model include “Proper noun: ΔΔ, Context: ‘leading actress’” and “Proper noun: □□, Context: ‘tourist spot’”. The AI model outputs category labels (e.g., movie 0.95, music 0.03, sports 0.02). Examples of outputs include “Category: movie (0.95)” or “Category: music (0.90)”. Based on the category determination results, the suggestion unit automatically selects an optimized suggestion algorithm for each category (e.g., referencing a movie database for the movie category, referencing a lyrics/artist dictionary for the music category, referencing a sports event/player name dictionary for the sports category, etc.) and executes proper noun candidate generation and addition of supplementary information. For training the AI model, datasets of proper nouns with category labels and data with category-specific suggestion accuracy labels are used, and cross-entropy loss functions and multi-task learning are applied. As a subsequent process, the category-specific suggestion results are reflected in data transfer to the candidate presentation unit and the selection unit. Unlike conventional uniform application of suggestion algorithms, the present suggestion unit achieves non-conventional and highly accurate proper noun suggestions through AI-based category determination and dynamic algorithm switching. As a technical effect, the system can automatically select suggestion methods suited to the content and category of the talk, greatly improving the accuracy of proper noun identification and user satisfaction. Application fields include not only general messenger apps, but also FAQ automatic response, medical record support, educational dialogue systems, customer support, and other diverse scenes where category-specific suggestions are useful.

The suggestion unit can estimate the user's emotion and adjust the length of suggestions based on the estimated emotion of the user. For example, the suggestion unit estimates the user's emotion, which may include, for example, relaxed, hurried, confused, and the like, but is not limited thereto. If the user is relaxed, the suggestion unit provides longer suggestions. If the user is in a hurry, the suggestion unit provides shorter suggestions. If the user is confused, the suggestion unit provides suggestions of appropriate length. By adjusting the length of suggestions according to the user's emotion, more appropriate suggestions can be provided. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the suggestion unit may be performed using AI, or may be performed without using AI. For example, the suggestion unit may input the user's emotion to AI and have the AI execute emotion estimation. Specifically, the suggestion unit extracts multidimensional feature vectors from text data, voice data, and input operation logs received from the user's input interface, and inputs them to an emotion estimation AI model (e.g., BERT-based emotion classifier, multimodal Transformer, etc.). Examples of inputs to the AI model include “Input text: ‘Please respond urgently’”, “Input speed: 2.5 characters/sec”, “Input interruption: 0 times”, etc. The AI model outputs emotion labels (e.g., relaxed, hurried, confused) and confidence scores (e.g., relaxed 0.65, hurried 0.30, confused 0.05). Examples of outputs include “Emotion: hurried (0.80)” or “Emotion: relaxed (0.70)”. Based on the output of the AI model, the suggestion unit selects a suggestion length control algorithm (e.g., long text generation, short text generation, summary generation, etc.), and automatically generates long suggestions with detailed explanations and supplementary information when relaxed is determined, short suggestions with only key points when hurried is determined, and suggestions of appropriate length considering clarity and information volume when confused is determined. For training the AI model, input datasets with emotion labels and data with suggestion length satisfaction labels are used, and cross-entropy loss functions and sequence length control learning are applied. As a subsequent process, the suggestion length control results are reflected in the rendering module of the user interface, and the optimal suggestion length suited to the user's psychological state and situation is automatically realized. Unlike conventional uniform suggestion lengths and static UIs, the present suggestion unit achieves dynamic suggestion length control based on AI analysis of multidimensional features and emotion estimation. As a technical effect, the system can automatically optimize suggestion length according to the user's psychological state and situation, resulting in improved information visibility, prevention of misrecognition, and enhanced user experience. Application fields include not only general messenger apps, but also business chat, medical case input support, educational dialogue systems, customer support, and other diverse scenes where suggestion length control according to user emotion is required.

The suggestion unit can determine the priority of suggestions based on the submission timing of the proper noun at the time of suggestion. For example, the suggestion unit determines the priority of suggestions based on the submission timing of the proper noun. Submission timing of proper nouns may include, for example, submission date and time, submission frequency, and the like, but is not limited thereto. The suggestion unit preferentially suggests recently used proper nouns, frequently used proper nouns in the past, or proper nouns related to specific periods. By determining the priority of suggestions based on the submission timing of proper nouns, important information for the user can be provided preferentially. Some or all of the above-described processing in the suggestion unit may be performed using AI, or may be performed without using AI. For example, the suggestion unit may input the submission timing of proper nouns to AI and have the AI execute priority determination. Specifically, the suggestion unit obtains the user's history of proper noun usage saved in chronological order (e.g., JSON structure including utterance ID, proper noun, usage date and time, usage frequency, up to 1000 entries) from the database, and extracts submission timing features for each proper noun candidate (e.g., latest usage date and time, number of uses in the past 30 days, appearance trends by period, etc.). The AI model (e.g., LSTM-based time series pattern recognition model, Transformer-based history analysis model, etc.) inputs these features and outputs priority scores for each proper noun (e.g., latest 0.95, frequent 0.80, past 0.10). Examples of inputs to the AI model include “Proper noun: ΔΔ, Latest use: 2024-06-01, Frequency: high” and “Proper noun: □□, Latest use: 2023-12-15, Frequency: low”. Examples of outputs include “Priority: ΔΔ (0.95)” and “Priority: □□ (0.10)”. Based on the output of the AI model, the suggestion unit applies a priority control algorithm (e.g., latest priority, frequent priority, period-based weighting, etc.) and presents proper nouns highly relevant to the user at the top. For training the AI model, paired data of history and user selection results, data with submission timing labels, etc. are used, and cross-entropy loss functions and ranking learning are applied. As a subsequent process, the priority control results are reflected in data transfer to the candidate presentation unit and the selection unit. Unlike conventional static candidate presentation or simple frequency reference, the present suggestion unit achieves information presentation suited to user usage trends through AI-based time series history analysis and dynamic priority control. As a technical effect, the system can preferentially provide information that the user needs most recently or frequently uses, greatly improving conversation efficiency and satisfaction. Application fields include not only general messenger apps, but also FAQ automatic response, medical record input support, educational dialogue systems, customer support, and other diverse scenes where history-linked information presentation is useful.

The suggestion unit can adjust the order of suggestions based on the relevance of the proper noun at the time of suggestion. For example, the suggestion unit adjusts the order of suggestions based on the relevance of the proper noun. Relevance of proper nouns may include, for example, co-occurrence relationships, relevance scores, and the like, but is not limited thereto. The suggestion unit preferentially suggests proper nouns most relevant to the context, then generally relevant proper nouns, and finally proper nouns with low relevance. By adjusting the order of suggestions based on the relevance of proper nouns, highly relevant information can be provided to the user preferentially. Some or all of the above-described processing in the suggestion unit may be performed using AI, or may be performed without using AI. For example, the suggestion unit may input the relevance of proper nouns to AI and have the AI execute the ordering of suggestions. Specifically, the suggestion unit integrates context features received from the analysis unit, proper noun candidate lists, past talk history, and knowledge base information, and calculates relevance scores for each proper noun (e.g., cosine similarity, co-occurrence frequency, context match degree, etc.). The AI model (e.g., Transformer-based relevance estimation model, graph neural network, etc.) receives as input context vectors (e.g., 512 tokens), candidate vectors (e.g., 5 items×128 dimensions), and history vectors (e.g., 100 items×256 dimensions), and outputs relevance scores for each proper noun (e.g., 0.90, 0.60, 0.20, etc.). Examples of inputs to the AI model include “Proper noun: ΔΔ, Context match: 0.92, Co-occurrence frequency: high” and “Proper noun: □□, Context match: 0.45, Co-occurrence frequency: low”. Examples of outputs include “Relevance: ΔΔ (0.90)” and “Relevance: □□ (0.45)”. Based on the output of the AI model, the suggestion unit rearranges proper noun candidates in order of relevance and presents the most relevant information to the user at the top. For training the AI model, data with proper nouns and relevance labels, user selection history, etc. are used, and cross-entropy loss functions and ranking learning are applied. As a subsequent process, the relevance-based presentation results are reflected in data transfer to the candidate presentation unit and the selection unit. Unlike conventional static candidate presentation or simple keyword matching, the present suggestion unit achieves information presentation suited to user intent and context through AI-based relevance estimation in high-dimensional vector space and dynamic order control. As a technical effect, the system improves access efficiency to information needed by the user and reduces confusion due to misselection or information overload. Application fields include not only general messenger apps, but also FAQ automatic response, medical record input support, educational dialogue systems, customer support, and other diverse scenes where relevance-based information presentation is useful.

The selection unit can estimate the user's emotion and adjust the selection method based on the estimated emotion of the user. For example, the selection unit estimates the user's emotion, which may include, for example, relaxed, hurried, confused, and the like, but is not limited thereto. If the user is relaxed, the selection unit provides detailed selection options. If the user is in a hurry, the selection unit provides concise selection options. If the user is confused, the selection unit provides easy-to-understand selection options. By adjusting the selection method according to the user's emotion, more appropriate selection options can be provided. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the selection unit may be performed using AI, or may be performed without using AI. For example, the selection unit may input the user's emotion to AI and have the AI execute emotion estimation. Specifically, the selection unit extracts multidimensional feature vectors from text data (e.g., UTF-8 encoded strings, up to 512 tokens), voice data (e.g., 16 kHz sampled PCM waveform, up to 30 seconds), and input operation logs (e.g., key input intervals, number of corrections, input interruption time, etc.) received from the user's input interface (e.g., software keyboard, voice recognition module). These features are input to an emotion estimation AI model (e.g., BERT-based emotion classifier, multimodal Transformer, etc.), which outputs emotion labels (e.g., relaxed, hurried, confused) and confidence scores (e.g., relaxed 0.70, hurried 0.20, confused 0.10). Examples of inputs to the AI model include “Input text: ‘Which should I choose?’”, “Input speed: 1.0 characters/sec”, “Input interruption: 2 times”, “Voice tone: calm”, etc. Examples of outputs include “Emotion: relaxed (0.70)” or “Emotion: hurried (0.20)”. Based on the output of the AI model, the selection unit selects a selection option presentation control algorithm (e.g., detailed option mode, concise option mode, clarity-focused mode, etc.). For example, when relaxed is determined, supplementary information and related history are displayed in detail for each option; when hurried is determined, only the main options are presented concisely; and when confused is determined, explanations and example sentences are added to each option for clarity. For training the AI model, input datasets with emotion labels and data with selection option presentation satisfaction labels are used, and cross-entropy loss functions and multi-task learning are applied. Examples of inputs to AI include “Input text: ‘I want to choose quickly’”, “Input speed: 3.0 characters/sec”, “Input interruption: 0 times”, etc., and examples of outputs include “Emotion: hurried (0.80)”. As a subsequent process, the selection option presentation control results are reflected in the rendering module of the user interface, and optimal selection option presentation suited to the user's psychological state and situation is automatically realized. Unlike conventional uniform selection option presentation or static UIs, the present selection unit achieves dynamic selection option presentation control based on AI analysis of multidimensional features and emotion estimation. As a technical effect, the system can automatically optimize selection option presentation according to the user's psychological state and situation, resulting in improved information visibility, prevention of misrecognition, and enhanced user experience. Application fields include not only general messenger apps, but also business chat, medical case input support, educational dialogue systems, customer support, and other diverse scenes where selection option presentation control according to user emotion is required.

The selection unit can refer to the user's past selection history at the time of selection to provide an optimal selection method. For example, the selection unit refers to the user's past selection history, which may include logs of selections made by the user in the past, but is not limited thereto. Based on the user's past selection history, the selection unit provides optimal selection options, prioritizes methods frequently selected by the user in the past, or detects specific patterns from the user's past selection history to provide optimal selection methods. By referring to the user's past selection history, optimal selection methods can be provided. Some or all of the above-described processing in the selection unit may be performed using AI, or may be performed without using AI. For example, the selection unit may input the user's past selection history to AI and have the AI execute history analysis. Specifically, the selection unit obtains selection history data saved in chronological order for each user (e.g., JSON structure including option ID, selection time, selection content, selection reason, context information at the time of selection, up to 1000 entries) from the database, extracts feature vectors (e.g., option category, selection frequency, selection success rate, selection time distribution, etc.), and inputs them to an AI model (e.g., LSTM-based time series pattern recognition model, Transformer-based history analysis model, etc.). Examples of inputs to the AI model include “Last 30 selections: 20 personal names, 5 place names, 5 product names”, “Selection success rate: personal names 0.98, place names 0.85”, “Selection time: mostly at night”, etc. The AI model outputs optimal selection methods (e.g., prioritize personal name selection, prioritize place name selection, combine product name selection, etc.) and recommendation scores (e.g., personal name 0.92, place name 0.08). Examples of outputs include “Recommended selection method: personal name (0.92)” or “Recommended selection method: place name (0.75)”. Based on the output of the AI model, the selection unit automatically selects or prioritizes recommended selection methods on the user interface, enabling efficient selection by the user. For training the AI model, paired data of history and user satisfaction/selection success rate are used, and cross-entropy loss functions and reinforcement learning are applied. As a subsequent process, recommended selection methods are reflected in the initial settings of the selection option presentation module and selection support triggers of the selection unit. Unlike conventional simple history reference or static selection method selection, the present selection unit achieves multidimensional history analysis and dynamic selection method optimization using AI. As a technical effect, the system can automatically propose selection methods suited to each user's selection tendencies and efficiency, resulting in reduced selection errors, improved selection speed, and optimized user experience. Application fields include not only general messenger apps, but also business chat, medical record input support, educational dialogue systems, customer support, and other diverse scenes where optimal selection support for each user is required.

The selection unit can customize selection options based on the user's current talk content at the time of selection. For example, the selection unit analyzes the user's current talk content, which may include, for example, the context of the conversation, related topics, and the like, but is not limited thereto. The selection unit preferentially provides selection options related to the user's current talk content, or provides options related to a specific topic if the user is talking about that topic. By analyzing the user's current talk content, the selection unit customizes and provides optimal selection options. By customizing selection options based on the user's current talk content, more appropriate selection options can be provided. Some or all of the above-described processing in the selection unit may be performed using AI, or may be performed without using AI. For example, the selection unit may input the user's talk content to AI and have the AI execute customization of selection options. Specifically, the selection unit analyzes text data (e.g., UTF-8 encoded strings, up to 512 tokens) and voice data (e.g., 16 kHz sampled PCM waveform, up to 30 seconds) received from the user's input interface in real time, and inputs them to a natural language processing module (e.g., Transformer-based large language model, BERT, LSTM, etc.). The selection unit extracts context features such as topic category, preceding subject/predicate, and missing proper noun positions from the input context, and generates related selection option candidates. Examples of inputs to the AI model include “Input text: ‘Recommended movies are . . . ’”, “Previous utterance: ‘The movie I watched yesterday was ◯◯’”, etc. The AI model outputs a list of selection options with relevance scores based on the input context (e.g., Movie Title A (0.85), Movie Title B (0.10), Movie Title C (0.05)). Examples of outputs include “Option: Movie Title A (0.85)” or “Option: Movie Title B (0.10)”. Based on the output of the AI model, the selection unit displays the selection options most relevant to the user's current talk content at the top, optimizing visibility and operability of the options. For training the AI model, data with talk content and selection option relevance labels, and user selection history are used for ranking learning (e.g., pairwise loss, listwise loss, etc.). As a subsequent process, customized selection options are reflected in the selection option presentation module of the user interface, enabling the user to easily make context-appropriate selections. Unlike conventional static selection option presentation or simple keyword matching, the present selection unit achieves non-conventional and highly accurate selection option customization through AI-based context understanding and dynamic selection option generation. As a technical effect, the system can automatically optimize selection option presentation according to the user's conversation content and intent, greatly improving selection accuracy and user satisfaction. Application fields include not only general messenger apps, but also FAQ automatic response, medical record input support, educational dialogue systems, customer support, and other diverse scenes where context-linked selection option presentation is useful.

The selection unit can estimate the user's emotion and determine the priority of selections based on the estimated emotion of the user. For example, the selection unit estimates the user's emotion, which may include, for example, impatience, relaxation, confusion, and the like, but is not limited thereto. If the user is impatient, the selection unit preferentially provides important selection options. If the user is relaxed, the selection unit provides options in the normal order. If the user is confused, the AI automatically provides selection options in an appropriate priority order. By determining the priority of selections according to the user's emotion, important selection options can be provided preferentially. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the selection unit may be performed using AI, or may be performed without using AI. For example, the selection unit may input the user's emotion to AI and have the AI execute emotion estimation. Specifically, the selection unit extracts multidimensional feature vectors from text data, voice data, and input operation logs (e.g., key input intervals, number of corrections, input interruption time, etc.) received from the user's input interface, and inputs them to an emotion estimation AI model (e.g., BERT-based emotion classifier, multimodal Transformer, etc.). Examples of inputs to the AI model include “Input text: ‘I want to choose urgently’”, “Input speed: 2.0 characters/sec”, “Input interruption: 0 times”, etc. The AI model outputs emotion labels (e.g., impatience, relaxation, confusion) and confidence scores (e.g., impatience 0.85, relaxation 0.10, confusion 0.05). Examples of outputs include “Emotion: impatience (0.85)” or “Emotion: confusion (0.60)”. Based on the output of the AI model, the selection unit executes a selection option priority determination algorithm (e.g., importance scoring, priority queue, etc.), and, for example, when “impatience” is determined, important selection options (e.g., missing proper noun positions, question sentences, etc.) are preferentially presented; when “relaxation” is determined, options are presented in the normal order; and when “confusion” is determined, the AI automatically adjusts the priority order. For training the AI model, input datasets with emotion labels and data with selection option priority labels are used, and cross-entropy loss functions and reinforcement learning are applied. As a subsequent process, priority determination results are reflected in the presentation order of the selection option presentation module and the display order of the user interface. Unlike conventional simple presentation order or static rule-based methods, the present selection unit achieves dynamic priority control based on AI analysis of multidimensional features and emotion estimation. As a technical effect, the system realizes selection option presentation suited to the user's psychological state and urgency, preventing oversight of important options, improving conversation efficiency, and optimizing user experience. Application fields include not only general messenger apps, but also business chat, medical case input support, educational dialogue systems, customer support, and other diverse scenes where selection option priority control is required.

The selection unit can provide optimal selection options based on the user's geographic location information at the time of selection. For example, the selection unit considers the user's geographic location information to provide optimal selection options. Geographic location information may include, for example, GPS data, location information services, and the like, but is not limited thereto. If the user is in a specific region, the selection unit preferentially provides options related to that region. If the user is traveling, the selection unit preferentially provides options related to the travel destination. If the user is in their hometown, the selection unit preferentially provides local options. By providing optimal selection options based on the user's geographic location information, region-related information can be provided. Some or all of the above-described processing in the selection unit may be performed using AI, or may be performed without using AI. For example, the selection unit may input the user's geographic location information to AI and have the AI execute the provision of selection options. Specifically, the selection unit obtains geographic location information acquired from the user terminal (e.g., GPS coordinates, Wi-Fi location information, region estimation based on IP address, etc.) in real time, extracts it as a location information vector (e.g., latitude/longitude, region code, movement history, etc.), and combines it with input text (e.g., UTF-8 encoded string, up to 512 tokens). The selection unit matches this information with a region-specific selection option dictionary (e.g., list of place names by prefecture, list of local specialties, tourist spot database, etc.). Furthermore, the selection unit inputs the location information vector and input text to an AI model (e.g., Transformer-based region relevance estimation model, geographic information embedding model, etc.), which calculates priority scores for region-specific selection options (e.g., local 0.90, travel destination 0.80, other regions 0.10). Examples of inputs to the AI model include “Location: Kita-ku, Osaka City”, “Input text: ‘Recommended gourmet foods are . . . ’”, etc. The AI model outputs a list of selection option candidates (e.g., takoyaki 0.85, okonomiyaki 0.80, kushikatsu 0.75) and priority labels. Examples of outputs include “Priority candidate: takoyaki (0.85)”. Based on the output of the AI model, the selection unit preferentially presents region-specific selection options, enabling the user to easily make selections suited to their current location or movement status. For training the AI model, input datasets with location information and region-related selection option labels are used, and cross-entropy loss functions and ranking learning are applied. As a subsequent process, the priority presentation results of region-specific selection options are reflected in the selection option presentation module of the user interface. Unlike conventional simple place name dictionary reference or static rule-based methods, the present selection unit achieves dynamic priority presentation of selection options based on AI integration of location information and context analysis. As a technical effect, the system can provide region-related information suited to the user's current location or movement status with high accuracy, improving user experience in tourist guidance, region-limited services, and local information support. Application fields include not only general messenger apps, but also tourist guide apps, region-focused services, business chat, educational dialogue systems, and other diverse scenes where location-linked selection support is required.

The selection unit can analyze the user's social media activity at the time of selection to suggest selection options. For example, the selection unit analyzes the user's social media activity, which may include, for example, post content, number of followers, and the like, but is not limited thereto. The selection unit preferentially provides selection options frequently used by the user on social media, or provides options related to topics discussed by the user on social media, or prioritizes options related to the user's social media activity. By analyzing the user's social media activity, relevant selection options can be provided. Some or all of the above-described processing in the selection unit may be performed using AI, or may be performed without using AI. For example, the selection unit may input the user's social media activity to AI and have the AI execute suggestion of selection options. Specifically, the selection unit collects post data (e.g., text posts, image captions, hashtags, post time, number of followers, engagement metrics, etc.) obtained from the user's linked social media accounts (e.g., microblogging, photo sharing services, video posting services, etc.) in chronological order, extracts feature vectors (e.g., frequent word list, topic category distribution, selection option appearance frequency, trend score, etc.), and combines them with the user's input text (e.g., UTF-8 encoded string, up to 512 tokens). The selection unit inputs these features to an AI model (e.g., Transformer-based topic relevance estimation model, graph neural network, etc.). Examples of inputs to the AI model include “Recent post: ‘The new movie ◯◯ was interesting’”, “Frequent options: ◯◯, ΔΔ ”, “Input text: ‘The leading actress is . . . ’”, etc. The AI model outputs a list of related selection option candidates (e.g., ◯◯ 0.90, ΔΔ 0.80, □□ 0.60) and priority scores. Examples of outputs include “Priority candidate: ◯◯ (0.90)” or “Priority candidate: ΔΔ (0.80)”. Based on the output of the AI model, the selection unit preferentially presents selection options and topics with high social media relevance, enabling the user to easily make selections suited to their latest interests and trends. For training the AI model, data with social media posts and selection option relevance labels are used, and cross-entropy loss functions and ranking learning are applied. As a subsequent process, priority presentation results are reflected in the selection option presentation module and display order of the user interface. Unlike conventional simple keyword frequency reference or static rule-based methods, the present selection unit achieves dynamic priority presentation of selection options based on AI analysis of social media activity and context integration. As a technical effect, the system can provide highly accurate related information suited to the user's latest interests and trends, enabling high-relevance conversation support, improved information freshness, and optimized user experience. Application fields include not only general messenger apps, but also SNS-linked chat, marketing support, educational dialogue systems, customer support, and other diverse scenes where social media-linked selection support is required.

The reference unit can estimate the user's emotion and select data to be referred to based on the estimated emotion of the user. For example, the reference unit estimates the user's emotion, which may include, for example, relaxed, hurried, confused, and the like, but is not limited thereto. If the user is relaxed, the reference unit refers to detailed data. If the user is in a hurry, the reference unit refers to simplified data. If the user is confused, the reference unit refers to highly accurate data. By selecting data to be referred to according to the user's emotion, more appropriate data can be provided. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the reference unit may be performed using AI, or may be performed without using AI. For example, the reference unit may input the user's emotion to AI and have the AI execute emotion estimation. Specifically, the reference unit extracts multidimensional feature vectors from text data (e.g., UTF-8 encoded strings, up to 512 tokens), voice data (e.g., 16 kHz sampled PCM waveform, up to 30 seconds), and input operation logs (e.g., key input intervals, number of corrections, input interruption time, etc.) received from the user's input interface (e.g., software keyboard, voice recognition module). These features are input to an emotion estimation AI model (e.g., BERT-based emotion classifier, multimodal Transformer, etc.), which outputs emotion labels (e.g., relaxed, hurried, confused) and confidence scores (e.g., relaxed 0.70, hurried 0.20, confused 0.10). Examples of inputs to the AI model include “Input text: ‘I want to know detailed information’”, “Input speed: 1.0 characters/sec”, “Input interruption: 2 times”, “Voice tone: calm”, etc. Examples of outputs include “Emotion: relaxed (0.70)” or “Emotion: hurried (0.20)”. Based on the output of the AI model, the reference unit selects a data selection algorithm (e.g., detailed data priority, simplified data priority, high-accuracy data priority, etc.), and refers to detailed related data (e.g., multiple references, detailed statistical data, supplementary images, etc.) when relaxed is determined, refers to simplified data (e.g., summary, main figures, bullet points, etc.) when hurried is determined, and refers to highly reliable data (e.g., official databases, verified information, etc.) when confused is determined. For training the AI model, input datasets with emotion labels and data selection satisfaction labels are used, and cross-entropy loss functions and multi-task learning are applied. Examples of inputs to AI include “Input text: ‘I want to know the result quickly’”, “Input speed: 3.0 characters/sec”, “Input interruption: 0 times”, etc., and examples of outputs include “Emotion: hurried (0.80)”. As a subsequent process, data selection results are reflected in the data acquisition module of the reference unit and the data transfer method to the analysis unit. Unlike conventional uniform data reference or static rule-based methods, the present reference unit achieves dynamic data selection control based on AI analysis of multidimensional features and emotion estimation. As a technical effect, the system can automatically optimize data reference according to the user's psychological state and situation, resulting in improved information reliability, optimized processing speed, and enhanced user experience. Application fields include not only general messenger apps, but also business chat, medical case reference support, educational dialogue systems, customer support, and other diverse scenes where data reference control according to user emotion is required.

The reference unit can refer to past talk history at the time of reference to optimize the analysis algorithm. For example, the reference unit refers to past talk history, which may include logs of conversations conducted by the user in the past, but is not limited thereto. The reference unit optimizes the analysis algorithm based on the user's past talk history, or based on proper nouns used by the user in the past, or detects specific patterns from the user's past talk history to optimize the analysis algorithm. By referring to past talk history, the accuracy of the analysis algorithm is improved. Some or all of the above-described processing in the reference unit may be performed using AI, or may be performed without using AI. For example, the reference unit may input past talk history to AI and have the AI execute optimization of the analysis algorithm. Specifically, the reference unit obtains up to 1000 utterance logs saved in chronological order for each user (in JSON format, with timestamp, utterance content, topic tags, etc. attached to each utterance) from the database, and inputs them together with input text (e.g., UTF-8 encoded string, up to 512 tokens) to an AI model (e.g., Transformer-based history-referencing large language model, LSTM-based time series analysis model, etc.). The reference unit extracts features such as frequent proper noun lists, topic transition patterns, and user-specific language expressions from the history data, and calculates similarity with the input context (e.g., cosine similarity, vector inner product, etc.). Examples of inputs to the AI model include “Input text: ‘Recommended movies are . . . ’”, “Past utterance: ‘The movie I watched yesterday was ◯◯’”, “Frequent proper nouns: ◯◯, ΔΔ”, etc. The AI model outputs a history list with relevance scores (e.g., utterance ID123 (0.92), utterance ID87 (0.75)), and a proper noun candidate list (e.g., ΔΔ 0.85, □□ 0.10, xx 0.05). Examples of outputs include “Related history: utterance ID123 (0.92)” or “Proper noun candidate: ΔΔ (0.85)”. Based on the output of the AI model, the reference unit dynamically adjusts the weighting of the analysis algorithm and the priority of candidate generation. For training the AI model, paired data of history and correct proper nouns, and data with analysis accuracy labels depending on history reference are used, and cross-entropy loss functions and triplet loss are used for weight optimization. As a subsequent process, history reference results are reflected in the algorithm selection and candidate generation module of the analysis unit. Unlike conventional simple keyword search or static history reference, the present reference unit achieves non-conventional and highly accurate analysis algorithm optimization through AI-based integrated analysis of history in high-dimensional vector space and dynamic weighting. As a technical effect, the system enables analysis reflecting the user's past utterance tendencies and expression patterns, greatly improving the accuracy of proper noun identification and conversation continuity. Application fields include not only general messenger apps, but also business chat, FAQ automatic response, medical record support, educational dialogue systems, and other diverse text input support scenes where history reference is important.

The reference unit can estimate the user's emotion and adjust the frequency of reference based on the estimated emotion of the user. For example, the reference unit estimates the user's emotion, which may include, for example, nervousness, relaxation, hurry, and the like, but is not limited thereto. If the user is nervous, the reference unit refers to data frequently. If the user is relaxed, the reference unit refers to data at a normal frequency. If the user is in a hurry, the reference unit refers to data at the minimum necessary frequency. By adjusting the frequency of reference according to the user's emotion, more appropriate data can be provided. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the reference unit may be performed using AI, or may be performed without using AI. For example, the reference unit may input the user's emotion to AI and have the AI execute emotion estimation. Specifically, the reference unit extracts multidimensional feature vectors from text data (e.g., UTF-8 encoded strings, up to 512 tokens), voice data (e.g., 16 kHz sampled PCM waveform, up to 30 seconds), and input operation logs (e.g., key input intervals, number of corrections, input interruption time, etc.) received from the user's input interface (e.g., software keyboard, voice recognition module). These features are input to an emotion estimation AI model (e.g., BERT-based emotion classifier, multimodal Transformer, etc.), which outputs emotion labels (e.g., nervousness, relaxation, hurry) and confidence scores (e.g., nervousness 0.65, relaxation 0.25, hurry 0.10). Examples of inputs to the AI model include “Input text: ‘What should I do . . . ’”, “Input speed: 0.8 characters/sec”, “Input interruption: 5 times”, “Voice tone: high”, etc. Examples of outputs include “Emotion: nervousness (0.65)” or “Emotion: hurry (0.30)”. Based on the output of the AI model, the reference unit selects a reference frequency control algorithm (e.g., high-frequency reference mode, normal reference mode, low-frequency reference mode, etc.), and refers to multiple data sources in real time at high frequency when nervousness is determined, refers to data at normal timing when relaxation is determined, and refers only to the minimum necessary data when hurry is determined. For training the AI model, input datasets with emotion labels and data with reference frequency satisfaction labels are used, and cross-entropy loss functions and multi-task learning are applied. Examples of inputs to AI include “Input text: ‘I want to know right now’”, “Input speed: 3.0 characters/sec”, “Input interruption: 0 times”, etc., and examples of outputs include “Emotion: hurry (0.80)”. As a subsequent process, reference frequency control results are reflected in the data acquisition module and data transfer method to the analysis unit. Unlike conventional uniform data reference frequency or static rule-based methods, the present reference unit achieves dynamic reference frequency control based on AI analysis of multidimensional features and emotion estimation. As a technical effect, the system can automatically optimize data reference frequency according to the user's psychological state and situation, resulting in improved information freshness, optimized communication load, and enhanced user experience. Application fields include not only general messenger apps, but also business chat, medical case reference support, educational dialogue systems, customer support, and other diverse scenes where reference frequency control according to user emotion is required.

The reference unit can weight reference data based on the submission timing of the talk at the time of reference. For example, the reference unit weights reference data based on the submission timing of the talk. Submission timing of the talk may include, for example, submission date and time, submission frequency, and the like, but is not limited thereto. The reference unit preferentially refers to recent talk history, appropriately weights and refers to past talk history, or weights and refers to talk history related to specific periods. By weighting reference data based on the submission timing of the talk, more appropriate data can be provided. Some or all of the above-described processing in the reference unit may be performed using AI, or may be performed without using AI. For example, the reference unit may input the submission timing of the talk to AI and have the AI execute data weighting. Specifically, the reference unit obtains talk history data saved in chronological order for each user (e.g., JSON structure including utterance ID, utterance content, submission date and time, submission frequency, up to 1000 entries) from the database, and extracts submission timing features for each talk history (e.g., latest usage date and time, number of uses in the past 30 days, appearance trends by period, etc.). The AI model (e.g., LSTM-based time series pattern recognition model, Transformer-based history analysis model, etc.) inputs these features and outputs weighting scores for each history data (e.g., latest 0.95, frequent 0.80, past 0.10). Examples of inputs to the AI model include “Utterance ID: 123, Latest use: 2024-06-01, Frequency: high” and “Utterance ID: 456, Latest use: 2023-12-15, Frequency: low”. Examples of outputs include “Weighting: utterance ID123 (0.95)” and “Weighting: utterance ID456 (0.10)”. Based on the output of the AI model, the reference unit applies a weighting control algorithm (e.g., latest priority, frequent priority, period-based weighting, etc.) and preferentially refers to history data highly relevant to the user. For training the AI model, paired data of history and user selection results, data with submission timing labels, etc. are used, and cross-entropy loss functions and ranking learning are applied. As a subsequent process, weighting control results are reflected in the data acquisition module and data transfer to the analysis unit. Unlike conventional static history reference or simple frequency reference, the present reference unit achieves information reference suited to user usage trends through AI-based time series history analysis and dynamic weighting control. As a technical effect, the system can preferentially refer to information that the user needs most recently or frequently uses, greatly improving conversation efficiency and satisfaction. Application fields include not only general messenger apps, but also FAQ automatic response, medical record reference support, educational dialogue systems, customer support, and other diverse scenes where history-linked information reference is useful.

The candidate presentation unit can estimate the user's emotion and adjust the presentation method of candidates based on the estimated emotion of the user. For example, the candidate presentation unit estimates the user's emotion, which may include, for example, relaxed, hurried, confused, and the like, but is not limited thereto. If the user is relaxed, the candidate presentation unit presents detailed candidates. If the user is in a hurry, the candidate presentation unit presents concise candidates. If the user is confused, the candidate presentation unit presents easy-to-understand candidates. By adjusting the presentation method of candidates according to the user's emotion, more appropriate candidates can be provided. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the candidate presentation unit may be performed using AI, or may be performed without using AI. For example, the candidate presentation unit may input the user's emotion to AI and have the AI execute emotion estimation.

The candidate presentation unit can refer to the user's past selection history at the time of candidate presentation to present optimal candidates. For example, the candidate presentation unit refers to the user's past selection history, which may include logs of selections made by the user in the past, but is not limited thereto. Based on the user's past selection history, the candidate presentation unit presents optimal candidates, prioritizes candidates frequently selected by the user in the past, or detects specific patterns from the user's past selection history to present optimal candidates. By referring to the user's past selection history, optimal candidates can be provided. Some or all of the above-described processing in the candidate presentation unit may be performed using AI, or may be performed without using AI. For example, the candidate presentation unit may input the user's past selection history to AI and have the AI execute history analysis.

The candidate presentation unit can estimate the user's emotion and determine the priority of candidates based on the estimated emotion of the user. For example, the candidate presentation unit estimates the user's emotion, which may include, for example, impatience, relaxation, confusion, and the like, but is not limited thereto. If the user is impatient, the candidate presentation unit preferentially presents important candidates. If the user is relaxed, the candidate presentation unit presents candidates in the normal order. If the user is confused, the AI automatically presents candidates in an appropriate priority order. By determining the priority of candidates according to the user's emotion, important candidates can be provided preferentially. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the candidate presentation unit may be performed using AI, or may be performed without using AI. For example, the candidate presentation unit may input the user's emotion to AI and have the AI execute emotion estimation.

The candidate presentation unit can present optimal candidates based on the user's geographic location information at the time of candidate presentation. For example, the candidate presentation unit considers the user's geographic location information to present optimal candidates. Geographic location information may include, for example, GPS data, location information services, and the like, but is not limited thereto. If the user is in a specific region, the candidate presentation unit preferentially presents candidates related to that region. If the user is traveling, the candidate presentation unit preferentially presents candidates related to the travel destination. If the user is in their hometown, the candidate presentation unit preferentially presents local candidates. By presenting optimal candidates based on the user's geographic location information, region-related information can be provided. Some or all of the above-described processing in the candidate presentation unit may be performed using AI, or may be performed without using AI. For example, the candidate presentation unit may input the user's geographic location information to AI and have the AI execute candidate presentation.

The reflection unit can estimate the user's emotion and adjust the reflection method based on the estimated emotion of the user. For example, the reflection unit estimates the user's emotion, which may include, for example, relaxed, hurried, confused, and the like, but is not limited thereto. If the user is relaxed, the reflection unit provides a detailed reflection method. If the user is in a hurry, the reflection unit provides a concise reflection method. If the user is confused, the reflection unit provides an easy-to-understand reflection method. By adjusting the reflection method according to the user's emotion, more appropriate reflection can be achieved. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the reflection unit may be performed using AI, or may be performed without using AI. For example, the reflection unit may input the user's emotion to AI and have the AI execute emotion estimation.

The reflection unit can refer to the user's past selection history at the time of reflection to provide an optimal reflection method. For example, the reflection unit refers to the user's past selection history, which may include logs of selections made by the user in the past, but is not limited thereto. Based on the user's past selection history, the reflection unit provides an optimal reflection method, prioritizes methods frequently selected by the user in the past, or detects specific patterns from the user's past selection history to provide an optimal reflection method. By referring to the user's past selection history, an optimal reflection method can be provided. Some or all of the above-described processing in the reflection unit may be performed using AI, or may be performed without using AI. For example, the reflection unit may input the user's past selection history to AI and have the AI execute history analysis.

The reflection unit can estimate the user's emotion and determine the priority of reflection based on the estimated emotion of the user. For example, the reflection unit estimates the user's emotion. The user's emotion may include, for example, impatience, relaxation, confusion, and the like, but is not limited thereto. For example, when the user is impatient, the reflection unit preferentially performs important reflection. When the user is relaxed, the reflection unit performs reflection in the normal order. When the user is confused, the AI performs reflection with an appropriate priority. Thus, by determining the priority of reflection according to the user's emotion, important reflection can be performed preferentially. Emotion estimation may be realized, for example, by using an emotion engine or a generative AI with an emotion estimation function. The generative AI may be a text generation AI (for example, LLM) or a multimodal generative AI, but is not limited thereto. Some or all of the above-described processing in the reflection unit may be performed using AI or without using AI. For example, the reflection unit may input the user's emotion to AI and have the AI perform emotion estimation.

The reflection unit can provide an optimal reflection method based on the user's geographic location information at the time of reflection. For example, the reflection unit provides an optimal reflection method in consideration of the user's geographic location information. The geographic location information may include, for example, GPS data, location information services, and the like, but is not limited thereto. For example, when the user is in a specific region, the reflection unit provides a reflection method related to that region. When the user is traveling, the reflection unit provides a reflection method for the travel destination. When the user is in their hometown, the reflection unit provides a reflection method for the hometown. Thus, by providing an optimal reflection method based on the user's geographic location information, information related to the region can be provided. Some or all of the above-described processing in the reflection unit may be performed using AI or without using AI. For example, the reflection unit may input the user's geographic location information to AI and have the AI provide the reflection method.

The system according to the embodiment is not limited to the above-described examples, and various modifications are possible, for example, as follows.

The reception unit can analyze the user's input speed when receiving the user's input and adjust the timing of invoking input assistance. For example, when the user is inputting at a slower speed than usual, the reception unit can immediately invoke input assistance. When the user is inputting at a high speed, the reception unit can delay the invocation of input assistance. Furthermore, when the user is inputting at a constant speed, the reception unit can invoke input assistance at the normal timing. Thus, input assistance can be provided at an appropriate timing according to the user's input speed.

The analysis unit can search for related images or videos based on the user's input content and improve the accuracy of context analysis. For example, when the user inputs “The lead actress of the movie is . . . ”, the analysis unit can search for movie posters or trailer videos and use them for context analysis. When the user inputs “Famous spots at the travel destination are . . . ”, the analysis unit can search for photos or sightseeing videos of the travel destination and use them for context analysis. Furthermore, when the user inputs “The name of the new gadget is . . . ”, the analysis unit can search for images or review videos of the gadget and use them for context analysis. Thus, by utilizing related images or videos, the accuracy of context analysis can be improved.

The suggestion unit can search for related news articles or blog articles based on the user's input content and use them for suggesting proper nouns. For example, when the user inputs “The lead actress of recent movies is . . . ”, the suggestion unit can search for news articles or blog articles related to recent movies and use them for suggesting proper nouns. When the user inputs “The name of the new smartphone is . . . ”, the suggestion unit can search for news articles or blog articles related to the new smartphone and use them for suggesting proper nouns. Furthermore, when the user inputs “The name of a famous tourist spot is . . . ”, the suggestion unit can search for news articles or blog articles related to the tourist spot and use them for suggesting proper nouns. Thus, by utilizing related news articles or blog articles, the accuracy of suggesting proper nouns can be improved.

The selection unit can customize the display order of selection options based on the user's selection history. For example, proper nouns that the user has frequently selected in the past can be displayed preferentially. The display order of selection options can also be adjusted based on the relevance of proper nouns previously selected by the user. Furthermore, the display order of selection options can be customized based on the category of proper nouns previously selected by the user. Thus, by customizing the display order of selection options based on the user's selection history, more appropriate selection options can be provided.

The reception unit can estimate the user's emotion and customize the content of input assistance based on the estimated emotion of the user. For example, when the user is impatient, the reception unit can provide concise and prompt input assistance. When the user is relaxed, the reception unit can provide detailed and courteous input assistance. Furthermore, when the user is confused, the reception unit can provide easy-to-understand and friendly input assistance. Thus, by customizing the content of input assistance according to the user's emotion, more appropriate assistance can be provided.

The analysis unit can search for related audio data based on the user's input content and improve the accuracy of context analysis. For example, when the user inputs “A part of a famous speech is . . . ”, the analysis unit can search for audio data of the speech and use it for context analysis. When the user inputs “The lyrics of a popular song are . . . ”, the analysis unit can search for audio data of the song and use it for context analysis. Furthermore, when the user inputs “An episode of a specific podcast is . . . ”, the analysis unit can search for audio data of the podcast and use it for context analysis. Thus, by utilizing related audio data, the accuracy of context analysis can be improved.

The suggestion unit can search for related books or papers based on the user's input content and use them for suggesting proper nouns. For example, when the user inputs “The name of a famous author is . . . ”, the suggestion unit can search for books or papers related to the author and use them for suggesting proper nouns. When the user inputs “The name of a specific scientist is . . . ”, the suggestion unit can search for books or papers related to the scientist and use them for suggesting proper nouns. Furthermore, when the user inputs “The name of a historical figure is . . . ”, the suggestion unit can search for books or papers related to the figure and use them for suggesting proper nouns. Thus, by utilizing related books or papers, the accuracy of suggesting proper nouns can be improved.

The selection unit can estimate the user's emotion and adjust the display method of selection options based on the estimated emotion of the user. For example, when the user is impatient, the selection unit can provide concise and highly visible selection options. When the user is relaxed, the selection unit can provide selection options including detailed information. Furthermore, when the user is confused, the selection unit can provide easy-to-understand and friendly selection options. Thus, by adjusting the display method of selection options according to the user's emotion, more appropriate selection options can be provided.

The analysis unit can search for related statistical data or graphs based on the user's input content and improve the accuracy of context analysis. For example, when the user inputs “Data of economic indicators is . . . ”, the analysis unit can search for statistical data or graphs related to the economic indicators and use them for context analysis. When the user inputs “Graph of market trends is . . . ”, the analysis unit can search for statistical data or graphs related to market trends and use them for context analysis. Furthermore, when the user inputs “Data of population statistics is . . . ”, the analysis unit can search for statistical data or graphs related to population statistics and use them for context analysis. Thus, by utilizing related statistical data or graphs, the accuracy of context analysis can be improved.

The suggestion unit can estimate the user's emotion and customize the content of suggestions based on the estimated emotion of the user. For example, when the user is impatient, the suggestion unit can provide concise and prompt suggestions. When the user is relaxed, the suggestion unit can provide detailed and courteous suggestions. Furthermore, when the user is confused, the suggestion unit can provide easy-to-understand and friendly suggestions. Thus, by customizing the content of suggestions according to the user's emotion, more appropriate suggestions can be provided.

The following briefly describes the processing flow of Example of the Embodiment.

Step 1: The reception unit receives a user input. The user input may include, for example, text input, voice input, and the like, but is not limited thereto. For example, when the user cannot recall a proper noun while writing a talk in a messenger application, the reception unit invokes AI input assistance.

Step 2: The analysis unit analyzes context based on the input received by the reception unit. Context analysis may include, for example, the relationship before and after the conversation, related topics, and the like, but is not limited thereto. For example, the analysis unit analyzes context by referring to past talk history or a general database.

Step 3: The suggestion unit suggests proper nouns based on the context analyzed by the analysis unit. The suggestion of proper nouns may include, for example, personal names, place names, product names, and the like, but is not limited thereto. For example, the suggestion unit presents a plurality of candidates.

Step 4: The selection unit allows the user to select the proper noun suggested by the suggestion unit. For example, the selection unit reflects the user's selection. Thus, even if the user cannot recall a proper noun during a talk, the user can continue the conversation smoothly.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, analysis unit, suggestion unit, and selection unit is implemented by at least one of, for example, the smart device 14 and the data processing apparatus 12. For example, the reception unit is implemented by a control unit 46A of the smart device 14 and receives a user input. The analysis unit is implemented, for example, by a specific processing unit 290 of the data processing apparatus 12 and analyzes context. The suggestion unit is implemented, for example, by the specific processing unit 290 of the data processing apparatus 12 and suggests proper nouns. The selection unit is implemented, for example, by the control unit 46A of the smart device 14 and reflects the user's selection. The correspondence between each unit and the apparatus or control unit is not limited to the examples described above and various modifications are possible.

### Second Embodiment

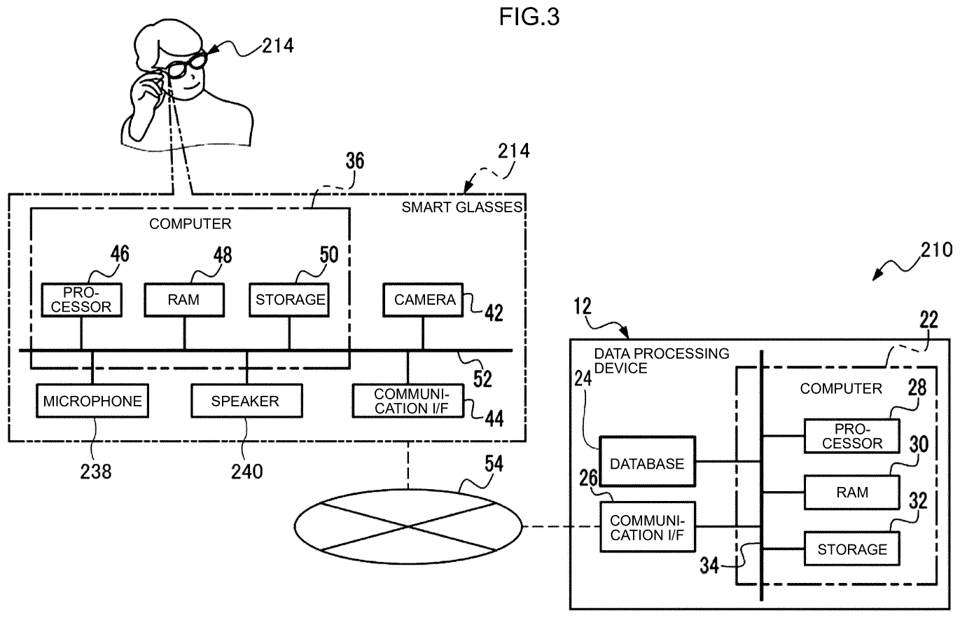

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

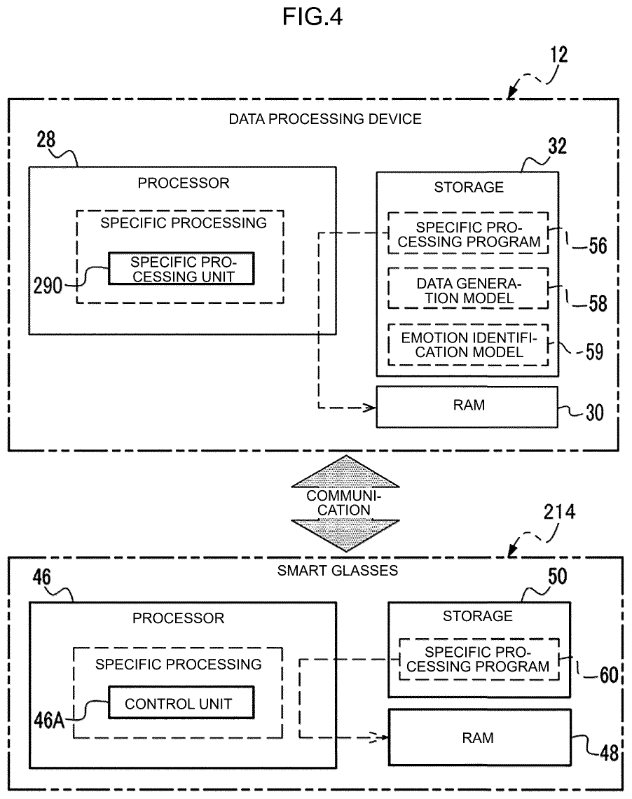

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, analysis unit, suggestion unit, and selection unit is implemented by at least one of, for example, the smart glasses 214 and the data processing apparatus 12. For example, the reception unit is implemented by a control unit 46A of the smart glasses 214 and receives a user input. The analysis unit is implemented, for example, by a specific processing unit 290 of the data processing apparatus 12 and analyzes context. The suggestion unit is implemented, for example, by the specific processing unit 290 of the data processing apparatus 12 and suggests proper nouns. The selection unit is implemented, for example, by the control unit 46A of the smart glasses 214 and reflects the user's selection. The correspondence between each unit and the apparatus or control unit is not limited to the examples described above and various modifications are possible.

### Third Embodiment

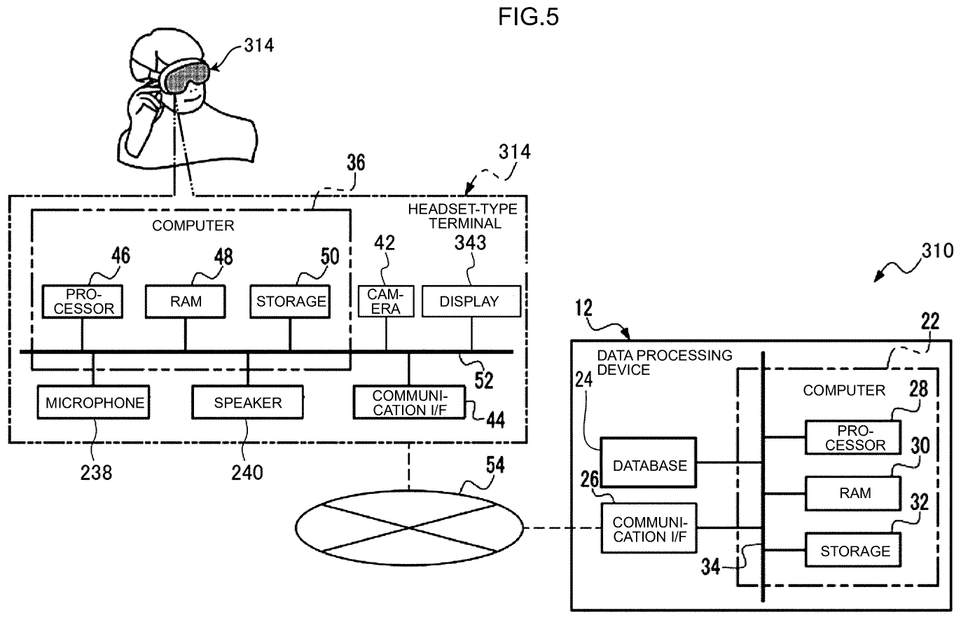

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

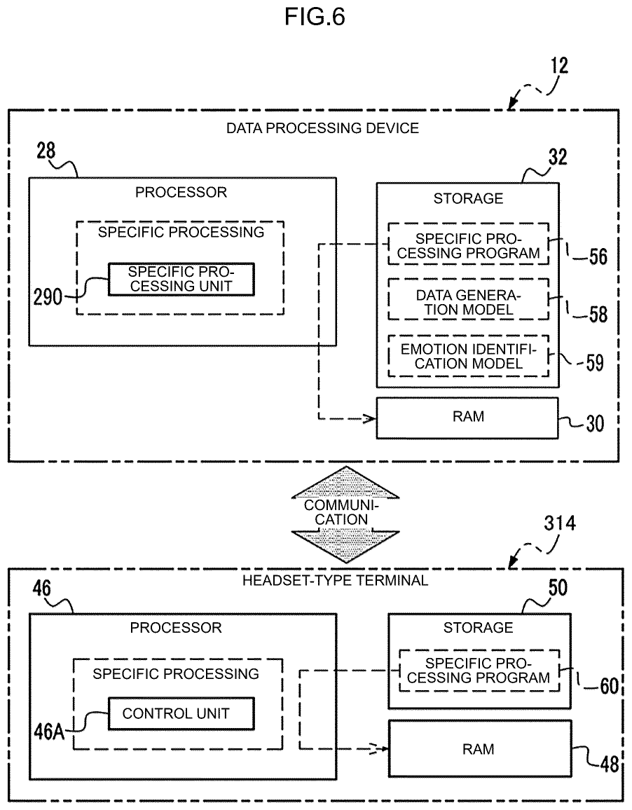

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, analysis unit, suggestion unit, and selection unit is implemented by at least one of, for example, the headset-type terminal 314 and the data processing apparatus 12. For example, the reception unit is implemented by a control unit 46A of the headset-type terminal 314 and receives a user input. The analysis unit is implemented, for example, by a specific processing unit 290 of the data processing apparatus 12 and analyzes context. The suggestion unit is implemented, for example, by the specific processing unit 290 of the data processing apparatus 12 and suggests proper nouns. The selection unit is implemented, for example, by the control unit 46A of the headset-type terminal 314 and reflects the user's selection. The correspondence between each unit and the apparatus or control unit is not limited to the examples described above and various modifications are possible.

### Fourth Embodiment

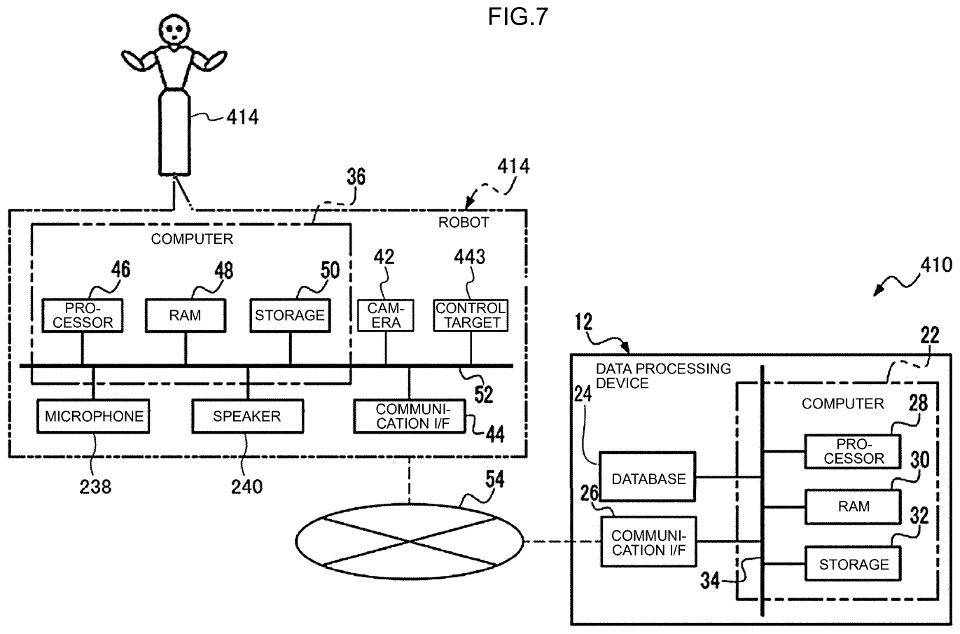

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

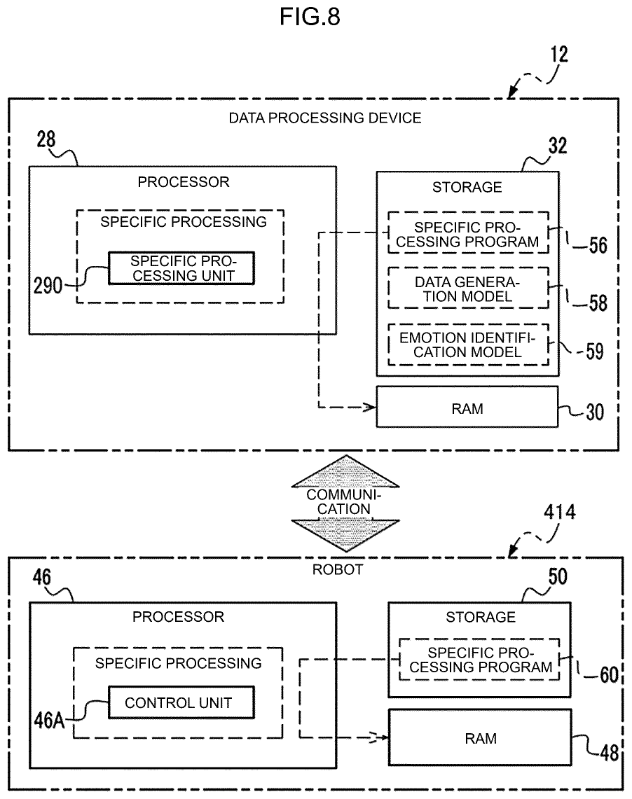

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, analysis unit, suggestion unit, and selection unit is implemented by at least one of, for example, the robot 414 and the data processing apparatus 12. For example, the reception unit is implemented by a control unit 46A of the robot 414 and receives a user input. The analysis unit is implemented, for example, by a specific processing unit 290 of the data processing apparatus 12 and analyzes context. The suggestion unit is implemented, for example, by the specific processing unit 290 of the data processing apparatus 12 and suggests proper nouns. The selection unit is implemented, for example, by the control unit 46A of the robot 414 and reflects the user's selection. The correspondence between each unit and the apparatus or control unit is not limited to the examples described above and various modifications are possible.

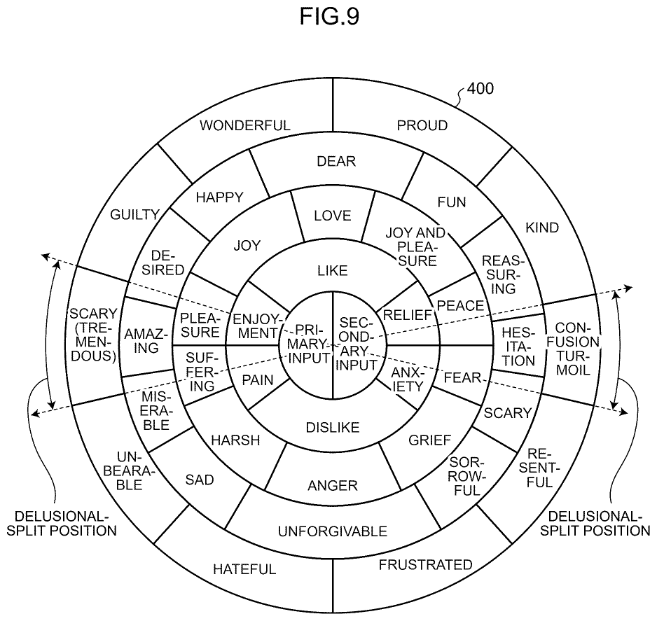

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac. jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

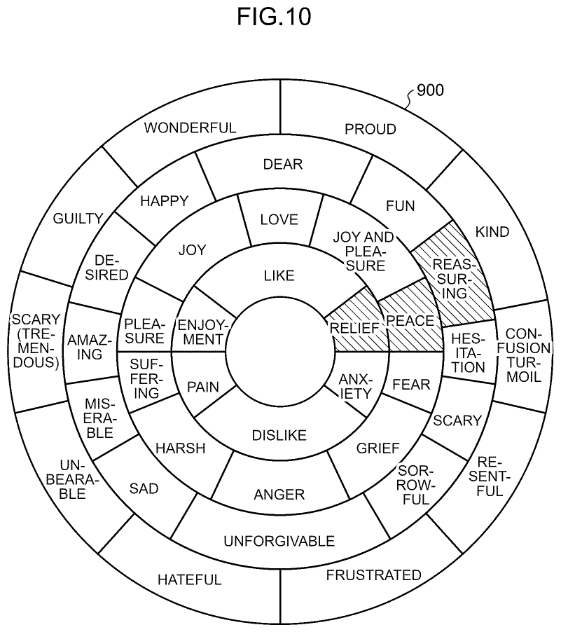

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a reception unit configured to receive a user input; an analysis unit configured to analyze context based on the input received by the reception unit; a suggestion unit configured to suggest proper nouns based on the context analyzed by the analysis unit; and a selection unit configured to allow the user to select the proper noun suggested by the suggestion unit.

(Supplementary Note 2) The system according to Supplementary Note 1, wherein the analysis unit comprises a reference unit configured to refer to past talk history or a general database.

(Supplementary Note 3) The system according to Supplementary Note 1, wherein the suggestion unit comprises a candidate presentation unit configured to present a plurality of candidates.

(Supplementary Note 4) The system according to Supplementary Note 1, wherein the selection unit comprises a reflection unit configured to reflect the user's selection.

(Supplementary Note 5) The system according to Supplementary Note 1, wherein the reception unit is configured to estimate the user's emotion and adjust the timing of invoking input assistance based on the estimated emotion of the user.

(Supplementary Note 6) The system according to Supplementary Note 1, wherein the reception unit is configured to analyze the user's past input history and select an appropriate reception method.

(Supplementary Note 7) The system according to Supplementary Note 1, wherein the reception unit is configured to automatically start reception using specific keywords or phrases as triggers according to the content of the talk.

(Supplementary Note 8) The system according to Supplementary Note 1, wherein the reception unit is configured to estimate the user's emotion and determine the priority of inputs to be received based on the estimated emotion of the user.

(Supplementary Note 9) The system according to Supplementary Note 1, wherein the reception unit is configured to preferentially receive region-specific proper nouns based on the user's geographic location information.

(Supplementary Note 10) The system according to Supplementary Note 1, wherein the reception unit is configured to analyze the user's social media activity and preferentially receive related inputs.

(Supplementary Note 11) The system according to Supplementary Note 1, wherein the analysis unit is configured to estimate the user's emotion and adjust the accuracy of context analysis based on the estimated emotion of the user.

(Supplementary Note 12) The system according to Supplementary Note 1, wherein the analysis unit is configured to refer to past talk history during context analysis to improve the accuracy of the analysis.

(Supplementary Note 13) The system according to Supplementary Note 1, wherein the analysis unit is configured to apply different analysis algorithms according to the category of the talk during context analysis.

(Supplementary Note 14) The system according to Supplementary Note 1, wherein the analysis unit is configured to estimate the user's emotion and adjust the display method of analysis results based on the estimated emotion of the user.

(Supplementary Note 15)The system according to Supplementary Note 1, wherein the analysis unit is configured to perform analysis based on the user's geographic location information during context analysis.

(Supplementary Note 16) The system according to Supplementary Note 1, wherein the analysis unit is configured to refer to relevant news or trend information during context analysis to improve the accuracy of the analysis.

(Supplementary Note 17) The system according to Supplementary Note 1, wherein the suggestion unit is configured to estimate the user's emotion and adjust the expression method of suggestions based on the estimated emotion of the user.

(Supplementary Note 18) The system according to Supplementary Note 1, wherein the suggestion unit is configured to adjust the level of detail of suggestions based on the importance of the proper noun at the time of suggestion.

(Supplementary Note 19) The system according to Supplementary Note 1, wherein the suggestion unit is configured to apply different suggestion algorithms according to the category of the proper noun at the time of suggestion.

(Supplementary Note 20) The system according to Supplementary Note 1, wherein the suggestion unit is configured to estimate the user's emotion and adjust the length of suggestions based on the estimated emotion of the user.

(Supplementary Note 21) The system according to Supplementary Note 1, wherein the suggestion unit is configured to determine the priority of suggestions based on the submission timing of the proper noun at the time of suggestion.

(Supplementary Note 22) The system according to Supplementary Note 1, wherein the suggestion unit is configured to adjust the order of suggestions based on the relevance of the proper noun at the time of suggestion.

(Supplementary Note 23) The system according to Supplementary Note 1, wherein the selection unit is configured to estimate the user's emotion and adjust the selection method based on the estimated emotion of the user.

(Supplementary Note 24) The system according to Supplementary Note 1, wherein the selection unit is configured to refer to the user's past selection history at the time of selection to provide an optimal selection method.

(Supplementary Note 25) The system according to Supplementary Note 1, wherein the selection unit is configured to customize selection options based on the user's current talk content at the time of selection.

(Supplementary Note 26) The system according to Supplementary Note 1, wherein the selection unit is configured to estimate the user's emotion and determine the priority of selections based on the estimated emotion of the user.

(Supplementary Note 27) The system according to Supplementary Note 1, wherein the selection unit is configured to provide optimal selection options based on the user's geographic location information at the time of selection.

(Supplementary Note 28) The system according to Supplementary Note 1, wherein the selection unit is configured to analyze the user's social media activity at the time of selection and suggest selection options.

(Supplementary Note 29) The system according to Supplementary Note 2, wherein the reference unit is configured to estimate the user's emotion and select data to be referred to based on the estimated emotion of the user.

(Supplementary Note 30) The system according to Supplementary Note 2, wherein the reference unit is configured to refer to past talk history at the time of reference to optimize the analysis algorithm.

(Supplementary Note 31) The system according to Supplementary Note 2, wherein the reference unit is configured to estimate the user's emotion and adjust the frequency of reference based on the estimated emotion of the user.

(Supplementary Note 32) The system according to Supplementary Note 2, wherein the reference unit is configured to weight reference data based on the submission timing of the talk at the time of reference.

(Supplementary Note 33) The system according to Supplementary Note 3, wherein the candidate presentation unit is configured to estimate the user's emotion and adjust the presentation method of candidates based on the estimated emotion of the user.

(Supplementary Note 34) The system according to Supplementary Note 3, wherein the candidate presentation unit is configured to refer to the user's past selection history at the time of candidate presentation to present optimal candidates.

(Supplementary Note 35) The system according to Supplementary Note 3, wherein the candidate presentation unit is configured to estimate the user's emotion and determine the priority of candidates based on the estimated emotion of the user.

(Supplementary Note 36) The system according to Supplementary Note 3, wherein the candidate presentation unit is configured to present optimal candidates based on the user's geographic location information at the time of candidate presentation.

(Supplementary Note 37) The system according to Supplementary Note 4, wherein the reflection unit is configured to estimate the user's emotion and adjust the reflection method based on the estimated emotion of the user.

(Supplementary Note 38) The system according to Supplementary Note 4, wherein the reflection unit is configured to refer to the user's past selection history at the time of reflection to provide an optimal reflection method.

(Supplementary Note 39) The system according to Supplementary Note 4, wherein the reflection unit is configured to estimate the user's emotion and determine the priority of reflection based on the estimated emotion of the user.

(Supplementary Note 40) The system according to Supplementary Note 4, wherein the reflection unit is configured to provide an optimal reflection method based on the user's geographic location information at the time of reflection.

What is claimed is:

1. A system comprising:
a communication interface configured to communicate with a client terminal via a packet-switched network;
a memory storing a data generation model obtained by deep learning on a neural network;
a database storing conversation history data; and
circuitry configured to:
receive, from the client terminal via the communication interface, text data representing a user input in a messenger application, the text data comprising a character string in which a proper noun is absent;
detect, from the character string, a pattern indicating an absence of the proper noun;
analyze context of the character string by inputting the character string and conversation history data retrieved from the database into the data generation model to extract contextual features comprising at least one of a topic category or a position of a missing proper noun;
generate, using the data generation model, a candidate list of proper nouns based on the extracted contextual features, each proper noun in the candidate list being associated with a relevance score;
transmit the candidate list to the client terminal via the communication interface and the packet-switched network, the candidate list causing the client terminal to display the candidate list to a user; and
receive, from the client terminal via the communication interface, selection data indicating a proper noun selected by the user from the candidate list, and store the selection data in the database as part of the conversation history data.

2. The system according to claim 1, wherein the circuitry is further configured to detect the pattern indicating the absence of the proper noun by applying at least one of regular expression pattern matching or a trigger phrase dictionary to the character string.

3. The system according to claim 1, wherein the data generation model comprises at least one of a Transformer-based large language model, a pre-trained BERT model, or an LSTM model, and wherein the circuitry is configured to extract the contextual features by calculating similarity between the character string and the conversation history data in a high-dimensional vector space.

4. The system according to claim 1, wherein the circuitry is further configured to retrieve, from an external knowledge base accessible via the communication interface, entries associated with a keyword or topic category extracted from the character string, and to generate the candidate list based on the retrieved entries and the extracted contextual features.

5. The system according to claim 1, wherein the memory further stores an emotion identification model, and wherein the circuitry is further configured to estimate an emotion of the user by applying the emotion identification model to at least one of the text data, voice data received from the client terminal, or input operation log data received from the client terminal, and to adjust a timing of transmitting the candidate list based on the estimated emotion.

6. The system according to claim 5, wherein the circuitry is further configured to adjust an accuracy mode of the context analysis based on the estimated emotion, such that when the estimated emotion indicates relaxation, the circuitry performs detailed context analysis, when the estimated emotion indicates urgency, the circuitry performs simplified context analysis, and when the estimated emotion indicates confusion, the circuitry performs high-accuracy context analysis.

7. The system according to claim 5, wherein the circuitry is further configured to adjust an expression method of the candidate list based on the estimated emotion, such that when the estimated emotion indicates relaxation, the circuitry generates the candidate list with detailed supplementary information, when the estimated emotion indicates urgency, the circuitry generates a concise candidate list, and when the estimated emotion indicates confusion, the circuitry generates the candidate list with explanatory information.

8. The system according to claim 1, wherein the circuitry is further configured to analyze the conversation history data stored in the database to extract at least one of a frequent proper noun list, a topic transition pattern, or a user-specific language expression, and to dynamically adjust a weighting of the relevance score for each proper noun in the candidate list based on the extracted information.

9. The system according to claim 1, wherein the circuitry is further configured to apply different context analysis algorithms according to a category of the character string, the category being determined by inputting the character string into a topic classifier, the category comprising at least one of a movie category, a music category, or a sports category.

10. The system according to claim 1, wherein the circuitry is further configured to adjust a level of detail of the candidate list based on an importance score calculated for each proper noun in the candidate list, such that the circuitry generates detailed supplementary information for proper nouns having a high importance score and concise labels for proper nouns having a low importance score.

11. The system according to claim 1, wherein the circuitry is further configured to apply different suggestion algorithms according to a category of the proper noun, the category comprising at least one of a personal name, a place name, or a product name.

12. The system according to claim 1, wherein the circuitry is further configured to determine a priority of proper nouns in the candidate list based on a submission timing of the proper noun in the conversation history data, such that a more recently used proper noun is assigned a higher priority.

13. The system according to claim 1, wherein the circuitry is further configured to adjust an order of proper nouns in the candidate list based on a relevance of each proper noun to the character string, the relevance being calculated based on at least one of a co-occurrence relationship or a context match degree in a high-dimensional vector space.

14. The system according to claim 1, wherein the circuitry is further configured to receive geographic location information from the client terminal via the communication interface, and to preferentially include region-specific proper nouns in the candidate list based on the geographic location information.

15. The system according to claim 1, wherein the circuitry is further configured to receive social media activity data of the user from the client terminal via the communication interface, and to preferentially include proper nouns associated with the social media activity data in the candidate list.

16. The system according to claim 1, wherein the circuitry is further configured to retrieve, via the communication interface, news data or trend information from a network-accessible source, and to adjust the relevance score of each proper noun in the candidate list based on the retrieved news data or trend information.

17. The system according to claim 1, wherein the circuitry is further configured to automatically insert the selected proper noun into the character string at the position of the missing proper noun and transmit the updated character string to the client terminal via the communication interface.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database storing conversation history data; and
circuitry configured to:
receive, from the client terminal via the communication interface, text data representing a user input in a messenger application, the text data comprising a character string in which a proper noun is absent;
detect, from the character string, a pattern indicating an absence of the proper noun using at least one of regular expression pattern matching or a trigger phrase dictionary;
analyze context of the character string by inputting the character string and conversation history data retrieved from the database into the data generation model, the data generation model comprising at least one of a Transformer-based large language model or a pre-trained BERT model, to extract contextual features;
estimate an emotion of the user by applying the emotion identification model to at least one of the text data or voice data received from the client terminal;
generate, using the data generation model, a candidate list of proper nouns based on the extracted contextual features, each proper noun being associated with a relevance score, and adjust a presentation method of the candidate list based on the estimated emotion;
transmit the candidate list to the client terminal via the communication interface, the candidate list causing the client terminal to display the candidate list to the user via the display; and
receive, from the client terminal via the communication interface, selection data indicating a proper noun selected by the user from the candidate list, and store the selection data in the database.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network, and a database storing conversation history data, the method comprising:
receiving, from a client terminal via the communication interface and a packet-switched network, text data representing a user input in a messenger application, the text data comprising a character string in which a proper noun is absent;
detecting, from the character string, a pattern indicating an absence of the proper noun;
analyzing context of the character string by inputting the character string and conversation history data retrieved from the database into the data generation model to extract contextual features comprising at least one of a topic category or a position of a missing proper noun;
generating, using the data generation model, a candidate list of proper nouns based on the extracted contextual features, each proper noun in the candidate list being associated with a relevance score;
transmitting the candidate list to the client terminal via the communication interface and the packet-switched network, the candidate list causing the client terminal to display the candidate list to a user; and
receiving, from the client terminal via the communication interface, selection data indicating a proper noun selected by the user from the candidate list, and storing the selection data in the database as part of the conversation history data.
